(19) United States
(12) Patent Application Publication
(10) Pub. No.: US 2008/0054115 A1
(43) Pub. Date: Mar. 6, 2008

(54) Tape drive device

(75) Inventor: Kenichi Hirano, Saitama (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/894,162

(22) Filed: Aug. 20, 2007

(30) Foreign Application Priority Data
Aug. 24, 2006 (JP) JP2006-227955
Aug. 24, 2006 (JP) JP2006-227956

(51) Int. Cl. G11B 15/32

(52) U.S. Cl. 242/355

(57) ABSTRACT

Disclosed herein is a tape drive device including: a flywheel; a pair of reel bases; an end detecting lever; and a selector lever; wherein the selector lever including a cam engaging member configured to engage the first cam of the flywheel to provide the tape transport mode and engage the second cam of the flywheel to provide the tape transport stop mode, depending on whether the selector lever is urged by the end detecting lever or not, a spring retainer fixed to the one of the reel bases between the chassis and the end detecting lever, a first load adjustment spring disposed between the spring retainer and the chassis configured to adjust a load applied in the direction of a rotational shaft of the one of the reel bases with respect to the chassis, and a second load adjustment spring disposed between the spring retainer and the end detecting lever configured to adjust a load applied in the direction of a rotational shaft of the end detecting lever with respect to the one of the reel bases.

### CROSS REFERENCES TO RELATED APPLICATIONS

The present invention contains subject matter related to Japanese Patent Application JP 2006-227955 filed in the Japan Patent Office on Aug. 24, 2006 and Japanese Patent Application JP 2006-227956 filed in the Japan Patent Office on Aug. 24, 2006, the entire contents of which being incorporated herein by reference.

### BACKGROUND OF THE INVENTION

1. Field of the Invention

The present invention relates to the art of tape drive devices, and more particularly to the art of facilitating the management of load adjustment with a first load adjustment spring for adjusting the load on a reel base and a second load adjustment spring for adjusting the load on an end detecting lever.

2. Description of the Related Art

Tape drive devices for recording an information signal on and reproducing an information signal from a tape-like recording medium, e.g., tape cassette players, have a reproducing mode for reproducing an information signal recorded on the tape-like recording medium, a recording mode for recording an information signal on the tape-like recording medium, a fast-forward mode for transporting the tape-like recording medium at a high speed in a normal direction to feed the tape-like recording medium fast, and a rewinding mode for transporting the tape-like recording medium at a high speed in a reverse direction to rewind the tape-like recording medium. These modes are achieved by a tape drive mechanism including various gears, levers, etc.

A tape drive device incorporates an automatic stop mechanism for detecting the end of the tape-like recording medium when it is transported and wound on the reel base up to its starting or terminal end, thereby automatically entering a tape transport stop mode (see, for example, Japanese Patent Laid-open No. 2001-155394).

There are various automatic stop mechanisms available in the art. According to one automatic stop mechanism, a selector lever is mounted rotatably on a chassis for selecting a tape transport mode or a tape transport stop mode, and when the starting or terminal end of the tape-like recording medium is detected by the end detecting lever while the tape-like recording medium is being transported, the selector lever is turned in a first turning direction to start the tape transport stop mode.

The end detecting lever is rotated in response to rotation of a reel base supported on the chassis. While the tape-like recording medium is being transported, the end detecting lever urges the selector lever to turn in a second turning direction that is opposite to the first turning direction, thereby holding the selector lever not to start the tape transport stop mode. When the end detecting lever detects the starting or terminal end of the tape-like recording medium, the end detecting lever releases the selector lever and allows it to turn in the first turning direction.

The end detecting lever is rotatably supported on the reel base for rotation between the reel base and the chassis, and is normally urged to be pressed against the reel base toward the rotational shaft thereof by a load adjustment spring for adjusting the load on the reel base.

### SUMMARY OF THE INVENTION

In the automatic stop mechanism, the load adjustment spring urges the end detecting lever to be pressed against the reel lever and also apply a rotational load (friction) on the reel base with respect to the chassis. Therefore, the load adjustment spring has a function to urge the end detecting lever against the reel base for rotating the end detecting lever in response to rotation of the reel base, and a function to urge the reel base to apply a frictional force to the reel base for preventing the tape-like recording medium from slacking as it is wound on the reel base.

When the tape drive device is used in a certain environment, e.g., at a high temperature, the urging force applied to the end detecting lever by the load adjustment spring tends to vary, reducing the urging force with which the end detecting lever turns the selector lever in the second turning direction. At this time, the selector lever is undesirably turned in the first turning direction, placing the tape drive device into the tape transport stop mode while the tape-like recording medium is being transported.

However, since the load adjustment spring has the two functions described above, the urging force applied by the load adjustment spring to the end detecting lever, which causes the above problem, may not be managed separately from the management of the urging force applied by the load adjustment spring to the reel base. It is therefore difficult to fully prevent the tape transport stop mode from happening while the tape-like recording medium is being transported.

According to an embodiment of the present invention, it is desirable to provide a tape drive device for facilitating the management of load adjustment on an end detecting lever.

According to an embodiment of the present invention, there is provided a tape drive device including a flywheel rotatable by drive power from a drive motor, the flywheel including a first cam positioned at a center of rotation thereof and a second cam positioned radially outwardly from the first cam. The tape drive device further including: a pair of reel bases for winding a tape-like recording medium thereon, the reel bases being rotatably supported on a chassis and rotatable by the drive power transmitted from the drive motor through the flywheel; and an end detecting lever for detecting a starting end or terminal end of the tape-like recording medium, the end detecting lever being rotatably supported on one of the reel bases and rotatable between the chassis and the one of the reel bases depending on rotation of the one of the reel bases. Yet further, the tape drive device including a selector lever angularly movably supported on the chassis for selectively switching between a tape transport mode and a tape transport stop mode depending on the angular position thereof, the selector lever being normally urged to turn in a predetermined direction by the end detecting lever while the reel bases are in rotation. The selector lever including a cam engaging member for engaging the first cam of the flywheel to provide the tape transport mode and engaging the second cam of the flywheel to provide the tape transport stop mode, depending on whether the selector lever is urged by the end detecting lever or not. A spring retainer fixed to the one of the reel bases between the chassis and the end detecting lever, a first load adjustment spring disposed between the spring retainer and the chassis for adjusting a load applied in the direction of a rotational shaft of the one of the reel bases with respect to the chassis. Moreover, a second load adjustment spring disposed between the spring retainer and the end detecting lever for adjusting a load applied in the direction of a rotational shaft of the end detecting lever with respect to the one of the reel bases.

In the above tape drive device, the reel base is urged by the first load adjustment spring, and the end detecting lever is urged by the second load adjustment spring.

According to an embodiment of the present invention, there is provided a tape drive device including a flywheel rotatable by drive power from a drive motor, the flywheel including a first cam positioned at a center of rotation thereof and a second cam positioned radially outwardly from the first cam. The tape drive device further including: a pair of reel bases for winding a tape-like recording medium thereon, the reel bases being rotatably supported on a chassis and rotatable by the drive power transmitted from the drive motor through the flywheel; and an end detecting lever for detecting a starting end or terminal end of the tape-like recording medium, the end detecting lever being rotatably supported on one of the reel bases and rotatable between the chassis and the one of the reel bases depending on rotation of the one of the reel bases. Yet further, the tape drive device including a selector lever angularly movably supported on the chassis for selectively switching between a tape transport mode and a tape transport stop mode depending on the angular position thereof, the selector lever being normally urged to turn in a predetermined direction by the end detecting lever while the reel bases are in rotation. The selector lever including a cam engaging member for engaging the first cam of the flywheel to provide the tape transport mode and engaging the second cam of the flywheel to provide the tape transport stop mode, depending on whether the selector lever is urged by the end detecting lever or not. A spring retainer fixed to the one of the reel bases between the chassis and the end detecting lever, a first load adjustment spring disposed between the spring retainer and the chassis for adjusting a load applied in the direction of a rotational shaft of the one of the reel bases with respect to the chassis. Moreover, a second load adjustment spring disposed between the spring retainer and the end detecting lever for adjusting a load applied in the direction of a rotational shaft of the end detecting lever with respect to the one of the reel bases.

The second load adjustment spring is used as a dedicated member for applying a load to the rotation of the end detecting lever with respect to the reel base. Therefore, the adjustment of the load on the rotation of the end detecting lever with respect to the reel base and the adjustment of the load on the rotation of the reel base with respect to the chassis are separately managed. The management of the load adjustment is thus facilitated.

According to an embodiment of the present invention, the tape drive device may further include a slider slidably supported on the chassis for conversion between the tape transport mode and the tape transport stop mode depending on the position thereof with respect to the chassis. When the cam engaging member of the selector lever is engaged by the second cam of the flywheel, the cam engaging member presses the slider to provide the tape transport mode. Therefore, the tape transport mode is provided simply and reliably.

According to an embodiment of the present invention, each of the first load adjustment spring and the second load adjustment spring may include a compression spring, and the first load adjustment spring and the second load adjustment spring may be held in substantially axial alignment with the centers of rotation of the reel bases. Accordingly, the load on the rotation of the reel base with respect to the chassis and the load on the rotation of the end detecting lever with respect to the reel base can be adjusted highly accurately, and the reel base and the end detecting lever are prevented from being shifted out of axial alignment while in rotation.

According to an embodiment of the present invention, the spring retainer may be of a circular profile, and the spring retainer may be held in substantially axial alignment with the centers of rotation of the one of the reel bases and the end detecting lever. Therefore, the spring retainer may be of a simple structure, and the reel base and the end detecting lever are prevented from being shifted out of axial alignment while in rotation.

According to an embodiment of the present invention, the tape drive device may further include a stop lever movably supported on the chassis for stopping transporting the tape-like recording medium when the stop lever is moved in a first direction, and an acting member for applying a turning force in the predetermined direction to the selector lever to cause the cam engaging member to engage the first cam of the flywheel when the stop lever is moved in the first direction. Consequently, when the drive motor rotates due to inertia, the cam engaging member does not engage the second cam, so that the tape drive device is prevented from malfunctioning and operates with increased reliability.

According to an embodiment of the present invention, the tape drive device may further include an ejection lever movably supported on the chassis for ejecting the tape-like recording medium. The ejection lever may eject a tape cassette housing the tape-like recording medium when the stop lever is moved in the first direction while the cam engaging member of the selector lever is engaging the first cam of the flywheel. Therefore, the tape cassette can reliably be ejected.

According to an embodiment of the present invention, the acting member may include a spring. Accordingly, the tape cassette can reliably be ejected by a simple structure.

The above and other features and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a perspective view of a tape drive device according to an embodiment of the present invention;

FIG. 2 is an enlarged front elevational view of a tape drive mechanism of the tape drive device according to an embodiment of the present invention;

FIG. 3 is an enlarged rear elevational view of the tape drive mechanism according to an embodiment of the present invention;

FIG. 4 is an enlarged front elevational view showing a chassis, a torsional coil spring supported on the chassis, and a selector lever supported on the chassis according to an embodiment of the present invention;

FIG. 5 is an enlarged exploded perspective view showing a flywheel and a cam engaging portion of the selector lever according to an embodiment of the present invention;

FIG. 6 is an enlarged front elevational view of the flywheel according to an embodiment of the present invention;

FIG. 7 is an enlarged front elevational view showing the relationship between a reel base and the selector lever according to an embodiment of the present invention;

FIG. 8 is an enlarged front elevational view of the tape drive mechanism with a subchassis removed according to an embodiment of the present invention;

FIG. 9 is an enlarged front elevational view of levers according to an embodiment of the present invention;

FIG. 10 is an enlarged front elevational view of a slider, a switching lever, and an ejection arm according to an embodiment of the present invention;

FIG. 11 is an enlarged front elevational view showing the tape drive mechanism in a stop mode;

FIG. 12 is an enlarged front elevational view showing the selector lever and other parts in the stop mode;

FIG. 13 is an enlarged front elevational view showing the tape drive mechanism in a fast-forward mode;

FIG. 14 is an enlarged front elevational view showing the tape drive mechanism in a rewinding mode;

FIG. 15 is an enlarged front elevational view showing the tape drive mechanism in a reproducing mode;

FIG. 16 is an enlarged front elevational view showing the tape drive mechanism in a recording mode;

FIG. 17 is an enlarged front elevational view showing the selector lever and other parts while the reel base is rotating in one direction in a tape transport mode;

FIG. 18 is an enlarged front elevational view showing the selector lever and other parts while the reel base is rotating in the other direction in the tape transport mode;

FIG. 19 is an enlarged front elevational view showing the tape drive mechanism in a pause mode;

FIG. 20 is an enlarged front elevational view showing the selector lever and other parts while a stop button is being pressed; and

FIG. 21 is an enlarged front elevational view showing the selector lever and other parts when an automatic stop mechanism is in operation.

### DETAILED DESCRIPTION OF THE PREFERRED EMBODIMENT

A tape drive device which is applied as a tape cassette player according to an embodiment of the present invention will be described below with reference to the drawings.

In the description which follows, various directions, e.g., forward, rearward, upward, downward, leftward, and rightward directions, will be referred to as viewed from the user of the tape drive device. For example, the forward direction is a direction toward the user, and the rearward direction is a direction away from the user. Directions in which various parts are rotated or turned are indicated as viewed from the front side of the tape drive device. A clockwise direction is referred to as an R1 direction, and a counterclockwise as an R2 direction. Various parts of the tape drive device are urged by springs, not shown, in various directions that are indicated by bold arrows.

The directions indicated below are illustrative, and should not be considered to be limitative in efforts to reduce the present invention to practice.

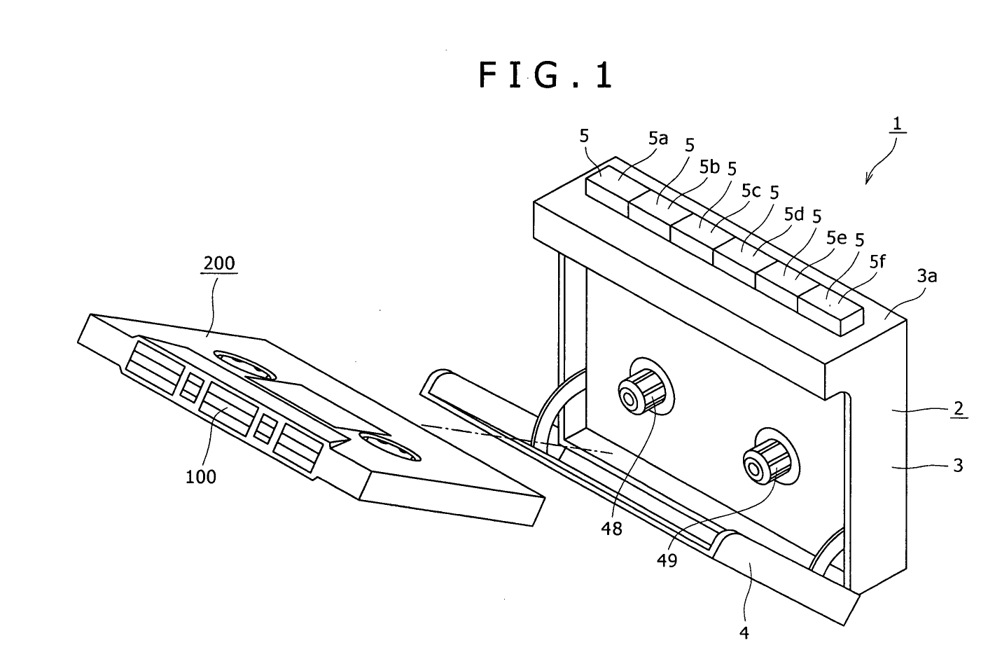

As shown in FIG. 1, the tape drive device, i.e., a tape cassette player 1, has its parts disposed in an outer casing 2. The outer casing 2 is of a horizontally elongate flat, substantially rectangular shape and includes a main body 3 and a lid 4 pivotally supported on the main body 3. The lid 4 serves as a substantially entire portion of a front panel of the outer casing 2, and has a lower end pivotally mounted on the main body 3.

The tape drive device includes a plurality of operation buttons 5 disposed at horizontally spaced intervals on an upper surface 3a of the main body 3. The operation buttons 5 can be pressed downwardly to operate interlinked members. The operation buttons 5 include, successively from the left, a pause button 5a for temporarily pausing the transportation of a tape-like recording medium 100, a stop/ejection button 5b for stopping the transportation of the tape-like recording medium 100 or ejecting the tape cassette 200, a fast-forward button 5c for transporting the tape-like recording medium 100 at a high speed in one direction (normal direction), a rewinding button 5d for transporting the tape-like recording medium 100 at a high speed in the other direction (reverse direction), a reproducing button 5e for reproducing information signals recorded on the tape-like recording medium 100, and a recording button 5f for recording information signals on the tape-like recording medium 100.

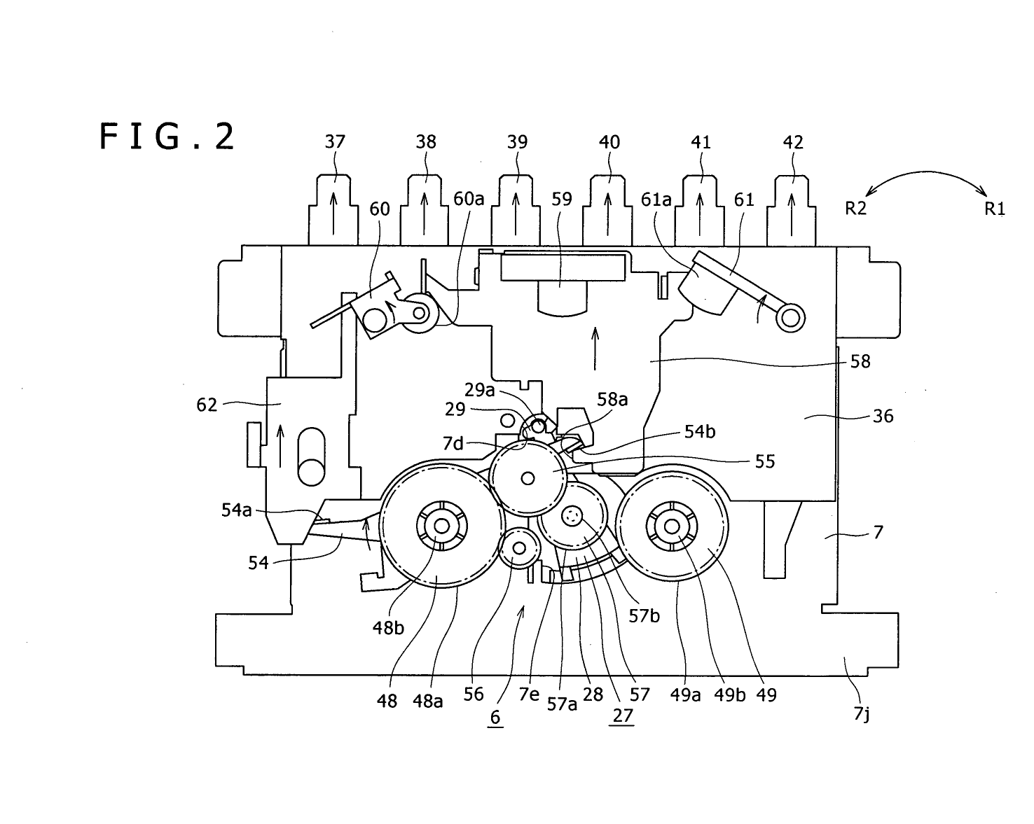

The tape drive device 1 includes a take drive mechanism 6 housed in the casing 2. Structural details of the take drive mechanism 6 will be described below with reference to FIGS. 2 through 10. In the description of the structural details of the take drive mechanism 6, it is assumed that the tape drive device 1 is in a stop mode wherein any of the operation buttons 5 are not pressed.

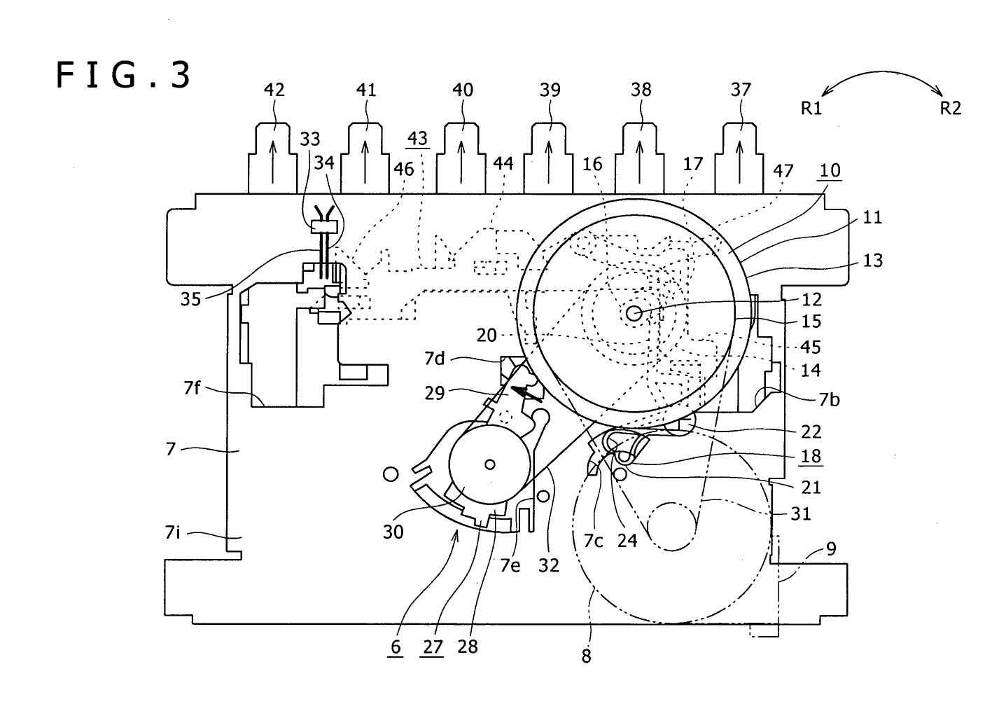

As shown in FIGS. 2 and 3, the tape drive mechanism 6 has its parts mounted on a chassis 7 disposed in the casing 2.

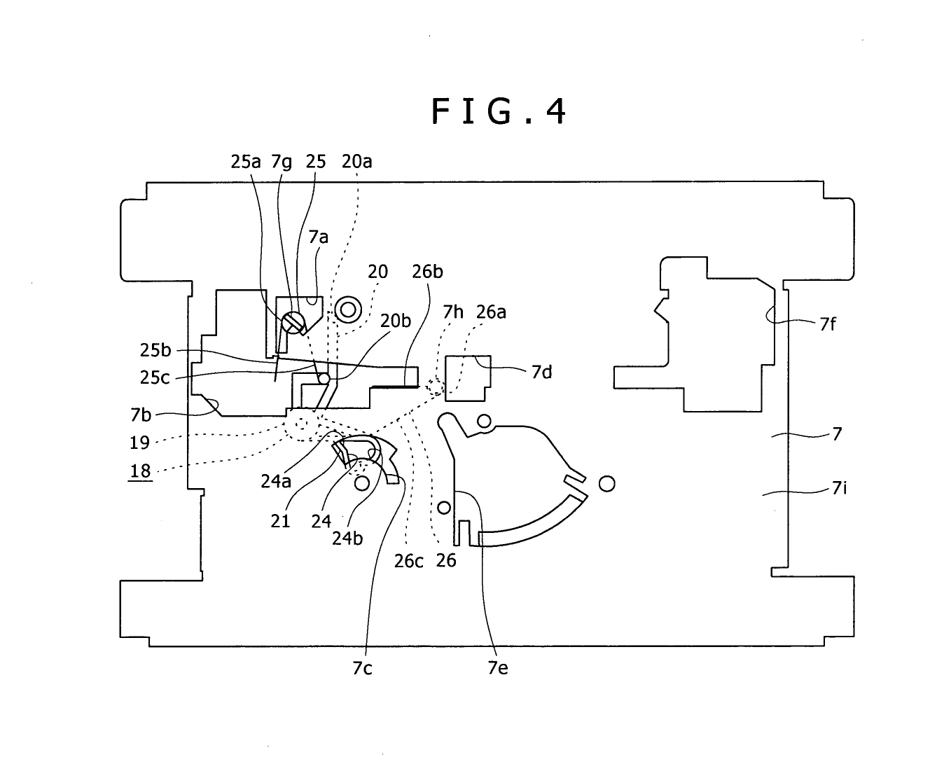

As shown in FIG. 4, the chassis 7 has a projection insertion hole 7a and a protrusion insertion hole 7b defined therein at respective positions near the left end of the chassis 7. The chassis 7 also has a lever insertion hole 7c defined therein at a position below the protrusion insertion hole 7b, a shaft insertion hole 7d defined therein at a substantially central upper position, and a placement hole 7e defined therein at a substantially central lower position. The chassis 7 has an operation member insertion hole 7f defined therein at a position near the right end of the chassis 7.

The chassis 7 has a first spring retainer 7g disposed on an opening edge of the projection insertion hole 7a and a second spring retainer 7h disposed at a position immediately rightward of the protrusion insertion hole 7b.

As shown in FIG. 3, a reversible drive motor 8 is mounted on a rear surface 7i of the chassis 7. The drive motor 8 is disposed on a motor base 9 attached to the chassis 7.

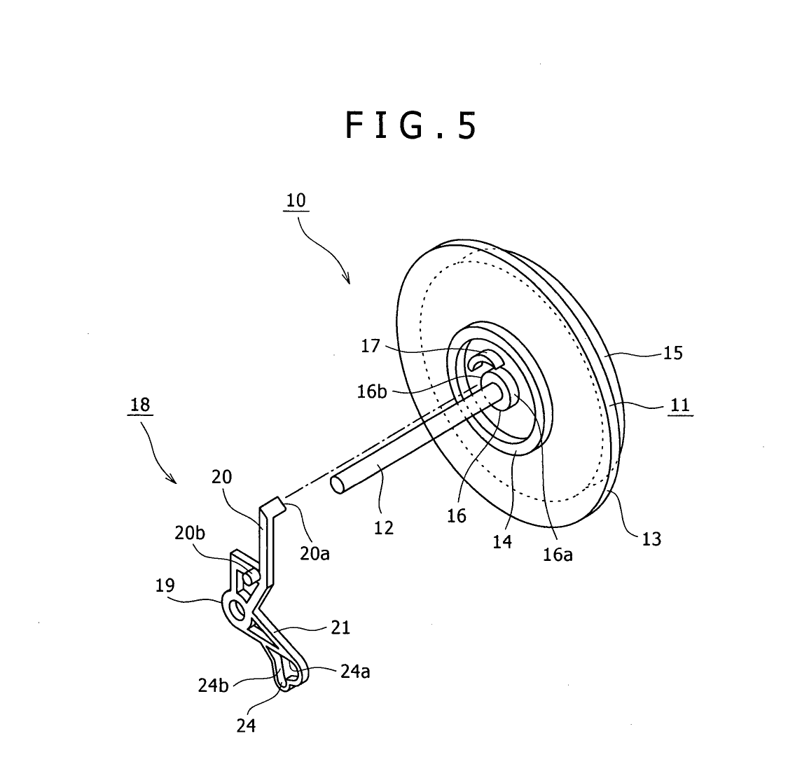

A flywheel 10 is rotatably supported on the rear surface 7i of the chassis 7 as shown in FIG. 3. As shown in FIG. 5, the flywheel 10 includes a circular plate portion 11 and a rotational shaft 12 fixed centrally to the circular plate portion 11. The rotational shaft 12 is supported on the chassis 7 at a position immediately rightward of the projection insertion hole 7a.

The circular plate portion 11 includes a main body 13, a small-diameter pulley 14 disposed on a front surface of the main body 13, and a large-diameter pulley 15 disposed on a rear surface of the main body 13.

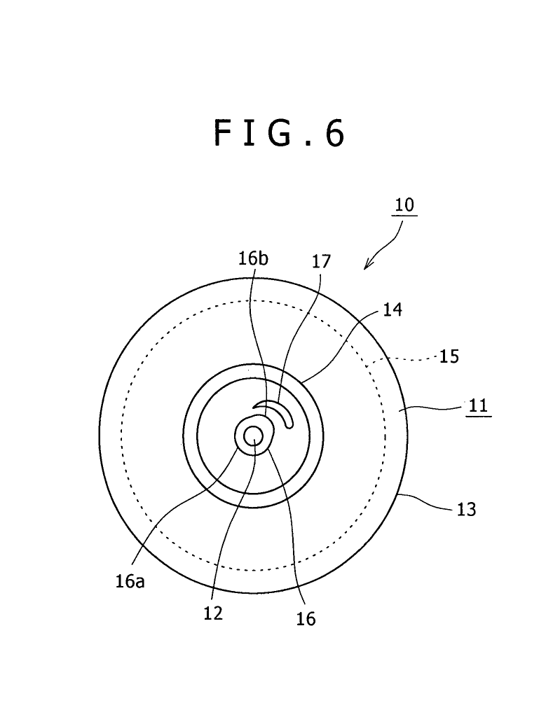

As shown in FIGS. 5 and 6, the small-diameter pulley 14 includes a first cam 16 at the center of rotation thereof and a second cam 17 disposed radially outwardly of the first cam 16. The first cam 16 includes an arcuate portion 16a which is spaced a constant distance from the center of rotation and a displacement portion 16b which is spaced a changing distance from the center of rotation, the displacement portion 16b being contiguous to the arcuate portion 16a. The distance from the center of rotation to the displacement portion 16b is greater than the distance from the center of rotation to the arcuate portion 16a. The second cam 17 is spaced radially outwardly from the displacement portion 16b and is substantially arcuately shaped.

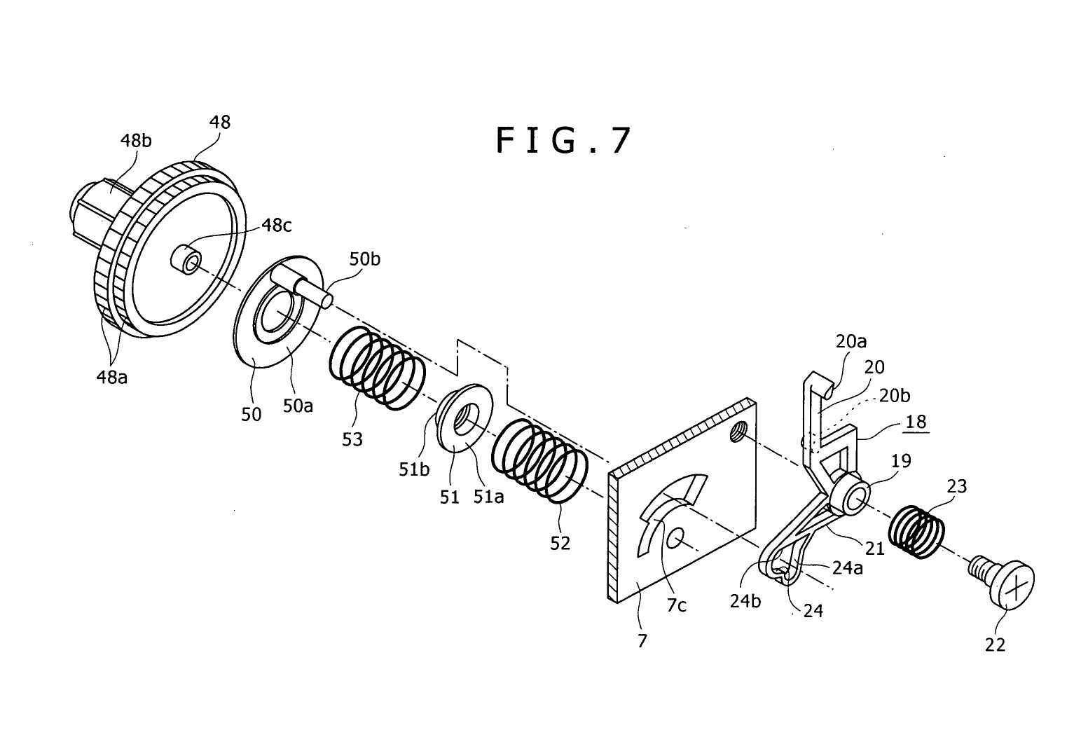

As shown in FIG. 3, a selector lever 18 is supported on the chassis 7 for angular movement about a pivot immediately below the protrusion insertion hole 7b. As shown in FIG. 7, the selector lever 18 is an integral member which includes a circular support 19, an arm 20 projecting radially outwardly from the circular support 19, and an acting protrusion 21 projecting radially outwardly from the circular support 19 in a direction different from the arm 20.

A support screw 22 is inserted through the circular support 19 and threaded into the chassis 7 with a compression spring 23 disposed between the support screw 22 and the circular support 19. The selector lever 18 is urged against the chassis 7 by the compression spring 23 and angularly movably supported frictionally on the chassis 7.

As shown in FIGS. 5 and 7, the arm 20 has a cam engaging finger 20a disposed on the distal end thereof and projecting rearwardly. As shown in FIG. 7, the arm 20 also has a spring support knob 20b disposed on an intermediate portion thereof and projecting forwardly. As shown in FIG. 3, the cam engaging finger 20a is positioned near the center of the flywheel 10 for selectively engaging the first cam 16 and the second cam 17 of the flywheel 10.

As shown in FIGS. 3 and 7, the acting protrusion 21 has a shaft insertion hole 24 defined in its distal end by a left opening presser edge 24a and a right opening presser edge 24b.

The selector lever 18 is shaped such that a force tending to turn the selector lever 18 in the R1 direction is applied thereto regardless of whether the left opening presser edge 24a or the right opening presser edge 24b is pressed.

As shown in FIG. 4, a first torsional coil spring 25 is supported on the first spring retainer 7g of the chassis 7. The first torsional coil spring 25 includes a coil portion 25a, a first arm 25b disposed on the left side of the coil portion 25a, and a second arm 25c disposed on the right side of the coil portion 25a. The coil portion 25a is supported on the first spring retainer 7g, and the second arm 25c engages a left surface of the spring support knob 20b of the selector lever 18.

A second torsional coil spring 26 is supported on the second spring retainer 7h of the chassis 7. The second torsional coil spring 26 includes a coil portion 26a, a first arm 26b disposed in an upper position, and a second arm 26c disposed in a lower position. The coil portion 26a is supported on the second spring retainer 7h, the first arm 26b extends through the protrusion insertion hole 7b and projects forwardly, and the second arm 26c engages an upper surface of the acting protrusion 21 of the selector lever 18.

As shown in FIGS. 2 and 3, an oscillating lever 27 is angularly movably supported on the rear surface 7i of the chassis 7 for angular movement about a position between the shaft insertion hole 7d and the placement hole 7e. The oscillating lever 27 is normally urged to turn in the R1 direction by a spring, not shown. The oscillating lever 27 is includes a support surface portion 28 and an actuated protrusion 29 projecting substantially upwardly from the support surface portion 28. An actuated shaft 29a projecting forwardly is mounted on the distal end of the actuated protrusion 29.

The oscillating lever 27 has a pivot on the actuated protrusion 29 near the support surface portion 28. The support surface portion 28 is disposed in the placement hole 7e, the actuated portion 29 is disposed in the shaft insertion hole 7d, and the actuated shaft 29a projects forwardly from the shaft insertion hole 7d.

A pulley 30 is rotatably supported on a rear surface of the support surface portion 28 of the oscillating lever 27.

A belt 31 is trained around the motor shaft of the drive motor 8 and the large-diameter pulley 15 of the flywheel 10, and a belt 32 is trained around the small-diameter pulley 14 of the flywheel 10 and the pulley 30. Therefore, when the drive motor 8 is energized to rotate its drive shaft, the drive power from the drive shaft is transmitted through the belt 31, the flywheel 10, and the belt 32 to the pulley 30, which is rotated about its own axis.

As shown in FIG. 3, a holder protrusion 33 is mounted on the rear surface 7i of the chassis 7 at a position near the right end thereof in an upper end portion thereof. The holder protrusion 33 holds a pair of horizontally spaced switch contacts 34, 35 projecting downwardly from the holder protrusion 33. When the switch contacts 34, 35 are brought into contact with each other, a power supply circuit is closed, supplying a drive current to the drive motor 8. The switch contacts 34, 35 have lower ends positioned directly behind the operation tooth insertion hole 7f in the chassis 7.

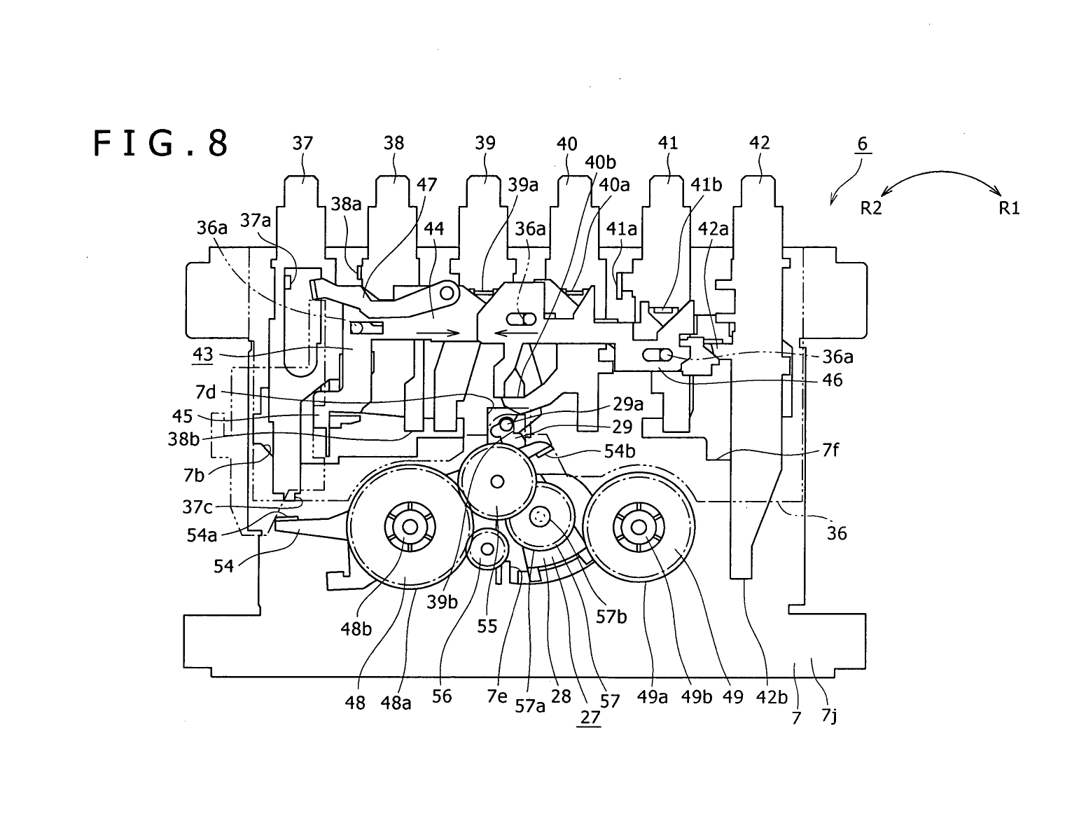

As shown in FIGS. 2 and 8, a subchassis 36 is mounted on a front surface 7j of the chassis 7 in covering relation to a substantially upper half portion of the chassis 7. Three support pints 36a that are horizontally spaced and project rearwardly are mounted on the subchassis 36.

As shown in FIG. 8, a pause lever 37, a stop lever 38, a fast-forward lever 39, a rewinding lever 40, a reproducing lever 41, and a recording lever 42 are vertically movably supported between the chassis 7 and the subchassis 36. The pause lever 37, the stop lever 38, the fast-forward lever 39, the rewinding lever 40, the reproducing lever 41, and the recording lever 42 are normally urged to move upwardly by respective springs, not shown.

The pause lever 37 is moved downwardly when the pause button 5a is pressed. The stop lever 38 is moved downwardly when the stop/ejection button 5b is pressed. The fast-forward lever 39 is moved downwardly when the fast-forward button 5c is pressed. The rewinding lever 40 is moved downwardly when the rewinding button 5d is pressed. The reproducing lever 41 is moved downwardly when the reproducing button 5e is pressed. The recording lever 42 is moved downwardly when the recording button 5f is pressed.

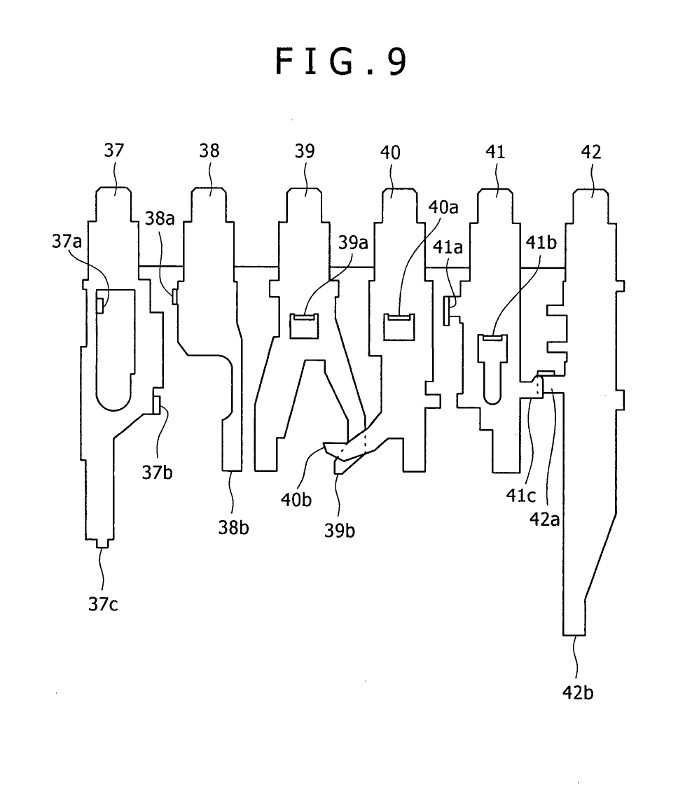

As shown in FIG. 9, the pause lever 37 has a presser tooth 37a positioned near an upper end thereof and projecting forwardly, a spring acting tooth 37b disposed on a substantially vertically central portion thereof and projecting rearwardly, and a presser 37c disposed on a lower end thereof. The presser tooth 37a projects forwardly from an insertion hole, not shown, defined in the subchassis 36. The spring acting tooth 37b projects rearwardly from the projection insertion hole 7a in the chassis 7. When the pause lever 37 is moved downwardly, the spring acting tooth 37b pushes the first arm 25b of the first torsional coil spring 25 to move to the right. The presser 37c projects downwardly from the subchassis 36 when the pause lever 37 is moved downwardly.

The stop lever 38 has a presser tooth 38a disposed on a substantially vertically central portion thereof and projecting forwardly. The stop lever 38 has a lower end acting as a spring presser 38b.

The fast-forward lever 39 has an acting tooth 39a disposed on a substantially vertically central portion thereof and projecting forwardly. The fast-forward lever 39 has a lower end portion acting as a sliding finger 39b. The sliding finger 39b is inclined to the right in an upward direction, and is capable of contacting a right surface of the actuated shaft 29a of the oscillating lever 27. Since the oscillating lever 27 is normally urged to turn in the R1 direction as described above, when the fast-forward lever 39 is moved downwardly, the sliding finger 39b slidingly engages the actuated shaft 29a, allowing the oscillating lever 27 to turn in the R1 direction under the bias of the spring.

The rewinding lever 40 has an acting tooth 40a disposed on a substantially vertically central portion thereof and projecting forwardly. The rewinding lever 40 has a lower end portion acting as a sliding finger 40b. The sliding finger 40b is inclined to the left in a downward direction, and is capable of contacting the right surface of the actuated shaft 29a of the oscillating lever 27. When the rewinding lever 40 is moved downwardly, the sliding finger 40b slidingly engages and presses the actuated shaft 29a, allowing the oscillating lever 27 to turn in the R2 direction under the bias of the spring.

The reproducing lever 41 has a coupling tooth 41a disposed on a substantially vertically central portion thereof at a left end thereof and projecting forwardly. The reproducing lever 41 also has an acting tooth 41b disposed at a position rightward of the coupling tooth 41a and an interlink finger 41c disposed near a lower end portion thereof and projecting to the right.

The recording lever 42 has a coupling tooth 42a disposed on a substantially vertically central portion thereof and projecting to the left. The recording lever 42 has a lower end portion serving as a limited protrusion 42b.

As shown in FIGS. 3 and 8, a slider 43 is horizontally movably supported between the chassis 7 and the subchassis 36. The slider 43 is normally urged to move to the right by a spring, not shown.

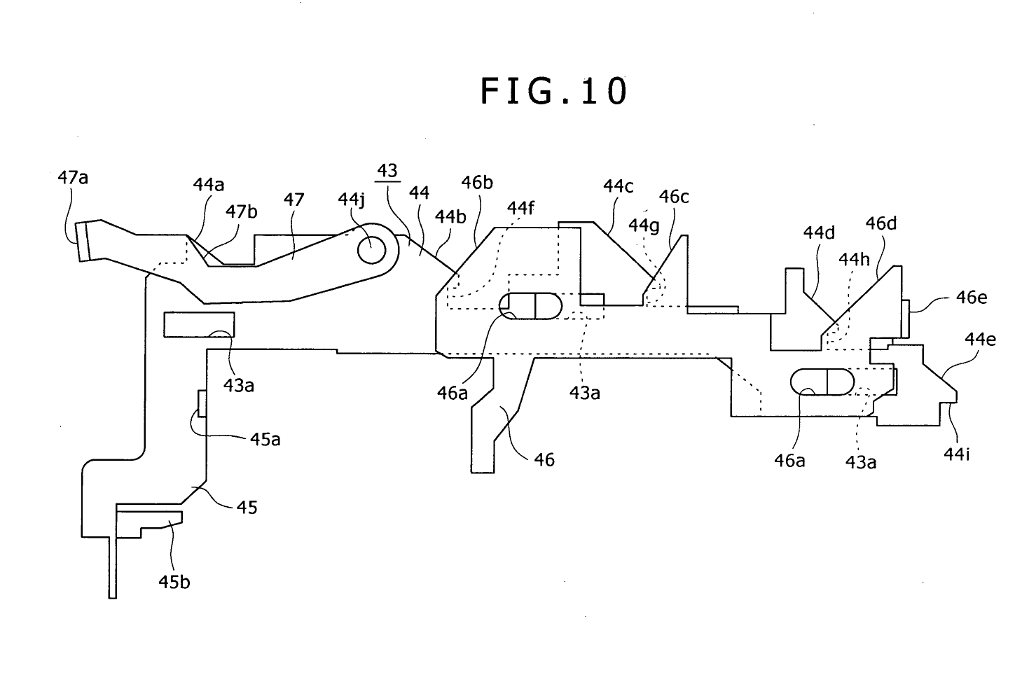

As shown in FIG. 10, the slider 43 includes a long horizontal member 44 and a vertical member 45 projecting downwardly from a left end of the horizontal member 44. The slider 43 includes three horizontally elongate supported holes 43a defined therein at horizontally spaced intervals. The slider 43 is guided to move horizontally with respect to the subchassis 36 by support pins 36a of the subchassis 36 which are inserted in the respective supported holes 43a.

The horizontal member 44 has five slanted edges 44a, 44b, 44c, 44d, 44e disposed at horizontally spaced intervals. The slanted edges 44a, 44b, 44c, 44d, 44e are inclined downwardly in the rightward direction. The horizontal member 44 also has rightwardly open lock recesses 44f, 44g, 44h, 44i defined therein immediately beneath the four slanted edges 44b, 44c, 44d, 44e. The horizontal member 44 has a support hole 44j defined therein between the slanted edge 44a and the slanted edge 44b.

The vertical member 45 has a pressed tooth 45a disposed near an upper end thereof. The pressed tooth 45a projects rearwardly from the projection insertion hole 7a of the chassis 7 and is positioned immediately leftwardly of the cam engaging finger 20a of the selector lever 18. A spring retainer 45b projects rightwardly from a lower end portion of the vertical member 45. The spring retainer 45b projects rearwardly from the protrusion insertion hole 7b of the chassis 7, and holds the first arm 25b of the first torsional coil spring 25.

As shown in FIGS. 3 and 8, a switching lever 46 is horizontally movably supported between the chassis 7 and the subchassis 36. The switching lever 46 is placed and supported on a front surface of the slider 43, and is normally urged to move to the left by a spring, not shown.

The switching lever 46 includes two horizontally elongate supported holes 46a defined therein at a horizontally spaced interval. The switching lever 46 is guided to move horizontally with respect to the subchassis 36 by support pins 36a of the subchassis 36 which are inserted in the respective supported holes 46a.

The switching lever 46 has three slanted edges 46b, 46c, 46d disposed at horizontally spaced intervals, as shown in FIG. 10. The slanted edges 46b, 46c, 46d are inclined downwardly in the leftward direction. The switching lever 46 also has a rearwardly projecting operation tooth 46e on a right end thereof. The operating tooth 46e projects rearwardly from the operation tooth insertion hole 7f of the chassis 7, and is positioned immediately leftwardly of the switch contacts 34, 35.

As shown in FIGS. 3 and 8, an ejection arm 47 is pivotally supported in the support hole 44j of the slider 43. The ejection arm 47 is substantially horizontally elongate and has a right end supported as a pivot in the support hole 44j. As shown in FIG. 10, a forwardly projecting presser tooth 47a is disposed on the left end of the ejection arm 47. The presser tooth 47a projects forwardly from an insertion hole, not shown, defined in the subchassis 36. The ejection arm 47 has a clearance recess 47b defined in an intermediate portion thereof and opening upwardly.

As shown in FIGS. 2 and 8, reel bases 48, 49 that are horizontally spaced from each other are rotatably supported on the front surface 7j of the chassis 7. The reel bases 48, 49 have respective gears 48a, 49a and respective mount bosses 48b, 49b projecting forwardly from the centers of the gears 48a, 49a.

As shown in FIG. 7, a hollow cylindrical fitting projection 48c projects rearwardly from the center of a rear surface of the gear 48a of the left reel base 48.

An end detecting lever 50 is rotatably supported on the rear surface of the gear 48a of the reel base 48. The end detecting lever 50 includes an annular plate 50a and a shaft 50b projecting rearwardly from the annular plate 50a.

A spring retainer 51 is fixed to the rear surface of the reel base 48. The spring retainer 51 includes a ring 51a and a fixed member 51b projecting forwardly from an inner peripheral edge of the ring 51a. The spring retainer 51 is secured, for example by press fitting, in position with the fixed member 51b extending through the central hole of the annular plate 50a and fitting over the fitting projection 48c of the reel base 48.

With the spring retainer 51 secured to the reel base 48, a first load adjustment spring 52 is disposed between the front surface 7j of the chassis 7 and the spring retainer 51, and a second load adjustment spring 53 is disposed between the spring retainer 51 and the ring 50a of the end detecting lever 50. Each of the first load adjustment spring 52 and the second load adjustment spring 53 are for example, a compression coil spring.

The first load adjustment spring 52 and the second load adjustment spring 53 have their axes aligned with the centers of rotation of the reel base 48 and the end detecting lever 50.

The first load adjustment spring 52 normally applies a load (friction) axially to the reel base 48 through the spring retainer 51. Therefore, the tape-like recording medium 100 can be wound on the reel base 48 without slacking or the like.

The second load adjustment spring 53 normally applies a load (friction) axially to the reel base 48 through the end detecting lever 50. Therefore, the end detecting lever 50 is pressed against the rear surface of the gear 48a of the reel base 48, and is rotatable in unison with the reel base 48 and also rotatable with respect to the reel base 48.

The shaft 50b of the end detecting lever 50 projects rearwardly from the lever insertion hole 7c of the chassis 7 and is inserted in the shaft insertion hole 24 of the selector lever 18.

A friction spring, not shown, is disposed between the gear 49a of the reel base 49 and the front surface 7j of the chassis 7. The friction spring normally applies a load (friction) axially to the reel base 49. Therefore, the tape-like recording medium 100 can be wound on the reel base 49 without slacking or the like.

As shown in FIGS. 2 and 8, a turn lever 54 is rotatably supported coaxially with the reel base 48 on the front surface 7j of the chassis 7. The first load adjustment spring 52 is compressed between the turn lever 54 and the spring retainer 51.

The turn lever 54 is elongate substantially horizontally, and is normally urged to turn in the R1 direction by a spring, not shown. The turn lever 54 has a pressed tooth 54a on a left end thereof and a borne tooth 54b on a right end thereof.

An interlink gear 55 is rotatably supported on the turn lever 54 near the right end thereof. The interlink gear 55 is held in mesh with the gear 48a of the reel base 48.

A transmission gear 56 is rotatably supported on the front surface 7j of the chassis 7 at a position immediately rightward of the reel base 48. The transmission gear 56 is held in mesh with the gear 48a of the reel base 48.

A two-step gear 57 is rotatably supported on the front surface of the support surface portion 28 of the oscillating lever 27 that is angularly movably supported on the chassis 7. The two-step gear 57 includes a large-diameter member 57a and a small-diameter member 57b, and has its rotational shaft coaxial with the rotational shaft of the pulley 30 supported on the rear surface of the support surface portion 28, so that the two-step gear 57 will rotate in unison with the pulley 30.

A vertical slider 58 is vertically movably supported on a horizontally central portion of the front surface of the subchassis 36. The vertical slider 58 is normally urged to move upwardly by a spring, not shown, and has an engaging finger 58a projecting leftwardly from a lower end portion thereof. The engaging finger 58a engages a lower surface of an engaged tooth 54b of the turn lever 54. When the vertical slider 58 is moved downwardly, the turn lever 54 is turned in the R1 direction under the bias of the spring, and when the vertical slider 58 is moved upwardly, the engaged tooth 54b is pressed upwardly by the engaging finger 58a, turning the turn lever 54 in the R2 direction against the bias of the spring.

The coupling tooth 41a of the reproducing lever 41 is coupled to an upper end portion of the vertical slider 58. The vertical slider 58 is vertically movable in unison with the reproducing lever 41.

A head 59 is mounted on the upper end portion of the vertical slider 58.

A roller unit 60 is angularly movably supported on the left end of an upper end portion of the subchassis 36. The roller unit 60 includes a pinch roller 60a. The roller unit 60 is normally biased by a spring, not shown to cause the pinch roller 60a to move substantially upwardly. Upon downward movement of the vertical slider 58, the pinch roller 60a is moved substantially downwardly. Upon upward movement of the vertical slider 58, the pinch roller 60a is moved substantially upwardly.

A magnetic head unit 61 is angularly movably supported on the right end of an upper end portion of the subchassis 36. The magnetic head unit 61 includes a magnetic head 61a. The magnetic head unit 61 is normally biased by a spring, not shown, to cause the magnetic head 61a to move substantially upwardly. Upon downward movement of the recording lever 42, the magnetic head 61a is moved substantially downwardly. Upon upward movement of the recording lever 42, the magnetic head 61a is moved substantially upwardly.

An ejection lever 62 is vertically movably supported on the left end of the subchassis 36. The ejection lever 62 is normally urged to move upwardly by a spring, not shown.

A recording lever limiting member, not shown, is angularly movably supported on the front surface 7j of the chassis 7 at a position near the right end of a lower end portion thereof, the recording lever limiting member being normally urged to move toward the front surface 7j. When a recordable tape cassette 200 is mounted on the reel bases 48, 49, the recording lever limiting member is angularly moved in a predetermined direction, allowing the recording lever 42 to move downwardly. When a tape cassette 200 which is configured to prevent recording is mounted on the reel bases 48, 49, the recording lever limiting member is not angularly moved, but engages the limited protrusion 42b of the recording lever 42, preventing the recording lever 42 from moving downwardly.

When the drive motor 8 of the tape drive mechanism 6 is energized, the drive power of the drive motor 8 is transmitted through the belt 31, the flywheel 10, and the belt 32 to the pulley 30, which is rotated about its own axis. When the pulley 30 is rotated, the two-step gear 57 is rotated in unison with the pulley 30. At this time, if the interlink gear 55 is held in mesh with the small-diameter member 57b of the two-step gear 57 and the gear 48a of the reel base 48, then the reel base 48 is rotated at a low speed upon rotation of the two-step gear 57. If the large-diameter member 57a of the two-step gear 57 is held in mesh with the transmission gear 56, then the reel base 48 is rotated at a high speed upon rotation of the two-step gear 57. If the large-diameter member 57a of the two-step gear 57 is held in mesh with the gear 49a of the reel base 49, then the reel base 49 is rotated at a high speed upon rotation of the two-step gear 57.

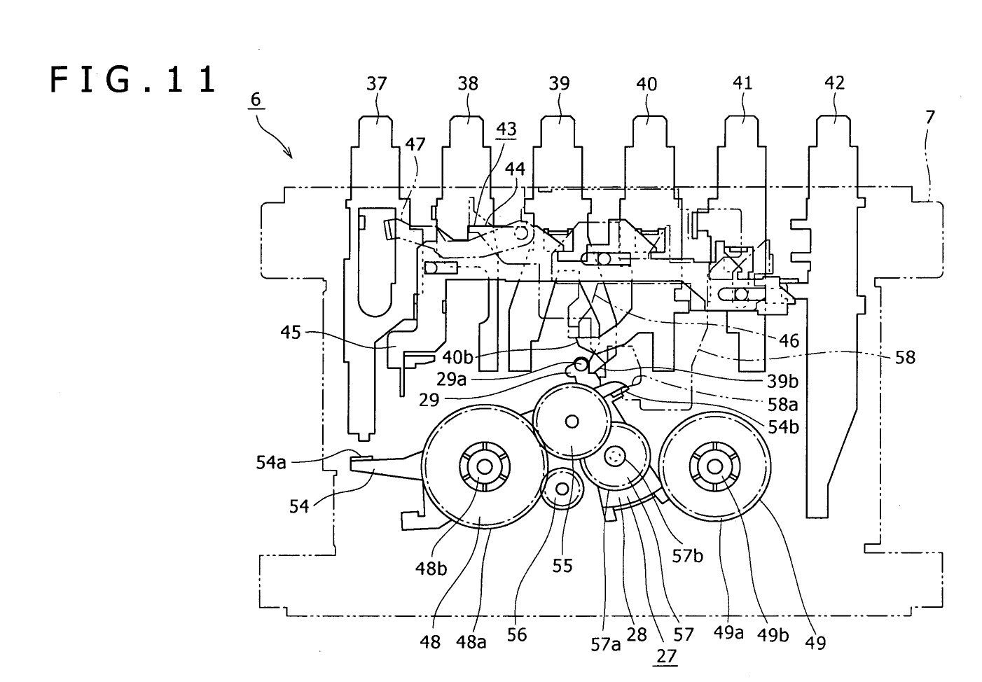

Operation of the tape drive mechanism 6 will be described below with reference to FIGS. 11 through 21.

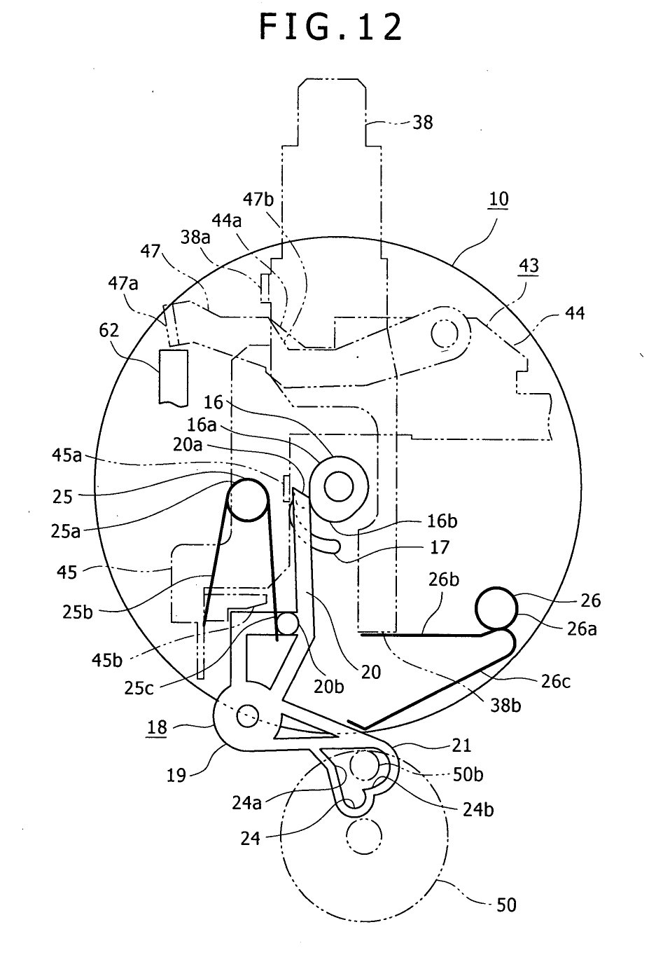

First, the stop mode in which the tape-like recording medium 100 is not transported will be described below with reference to FIGS. 11 and 12.

In the stop mode, as shown in FIG. 11, the pause lever 37, the stop lever 38, the fast-forward lever 39, the rewinding lever 40, the reproducing lever 41, and the recording lever 42 are not moved downwardly, but in their initial positions.

The oscillating lever 27 is held in an intermediate position in its angularly movable range with the actuated shaft 29a being engaged by the sliding finger 39b of the fast-forward lever 39. Therefore, the two-step gear 57 supported on the oscillating lever 27 is held out of mesh with the transmission gear 56 and the gear 49a of the reel base 49.

The slider 43 is positioned at the right end of its moving stroke. Since the slider 43 is positioned at the right end of its moving stroke, the first torsional coil spring 25 with the first arm 25b held by the spring retainer 45b has its second arm 25c pressing the spring support knob 20b of the selector lever 18 to the right, causing the cam engaging finger 20a of the selector lever 18 to be engaged by the first cam 16 of the flywheel 10, as shown in FIG. 12.

The second torsional coil spring 26 has the first arm 26b spaced from the stop lever 38 and also has the second arm 26c spaced from the selector lever 18.

As the ejection arm 47 is supported on the slider 43, the ejection arm 47 is also positioned at the right end of the movable stroke, with the presser tooth 47a being positioned immediately above the upper surface of the ejection lever 62.

As shown in FIG. 11, the switching lever 46 is positioned at the left end of its movable stroke, with the operation tooth 46e being spaced leftwardly from the switch contact 34. Therefore, the switch contacts 34, 35 are held out of contact with each other, switching off the drive motor 8 with its drive shaft stopped against rotation.

The borne tooth 54b of the turn lever 54 is engaged by the engaging finger 58a of the vertical slider 58 that is positioned in the upper end of its movable stroke, and is held at the end of the angularly movable range in the R2 direction. Therefore, the interlink gear 55 supported on the turn lever 54 is kept out of mesh with the two-step gear 57.

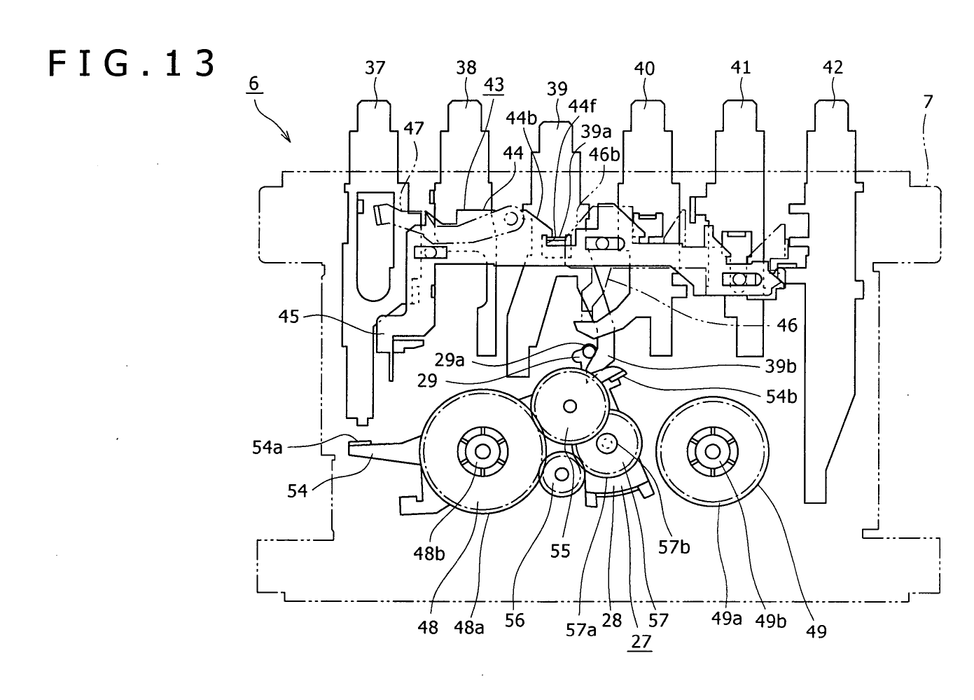

A transition from the stop mode to a fast-forward mode for transporting the tape-like recording medium 100 at a high speed in a normal direction will be described below with reference to FIG. 13.

The tape drive mechanism 6 enters the fast-forward mode when the fast-forward button 5c is pressed to move the fast-forward lever 39 downwardly in the stop mode.

When the fast-forward lever 39 is moved downwardly, the acting tooth 39a slides against the slanted edge 44b of the slider 43, moving the slider 43 to the left. When the fast-forward lever 39 reaches the lower end of its movable stroke, the acting tooth 39a is positioned immediately laterally of the lock recess 44f. The slider 43 is moved to the right by the spring, causing the acting tooth 39a to engage in the lock recess 44f, whereupon the fast-forward lever 39 is locked by the slider 43.

At the same time, the downward movement of the fast-forward lever 39 causes the acting tooth 39a to slide against the slanted edge 46b of the switching lever 46, moving the switching lever 46 to the right. When the switching lever 46 is moved to the right, the operation tooth 46e presses the switch contact 34. The switching contacts 34, 35 are brought into contact with each other, switching on the drive motor 8, i.e., supplying a drive current to the drive motor 8.

Upon the downward movement of the fast-forward lever 39, the sliding finger 39b and the actuated shaft 29a of the oscillating lever 27 slide against each other, turning the oscillating lever 27 in the R1 direction to bring the large-diameter member 57a of the two-step gear 57 into mesh with the transmission gear 56. Therefore, the drive power of the drive motor 8 is transmitted from the large-diameter member 57a of the two-step gear 57 through the transmission gear 56 to the reel base 48, which is rotated at a high speed to wind the tape-like recording medium 100.

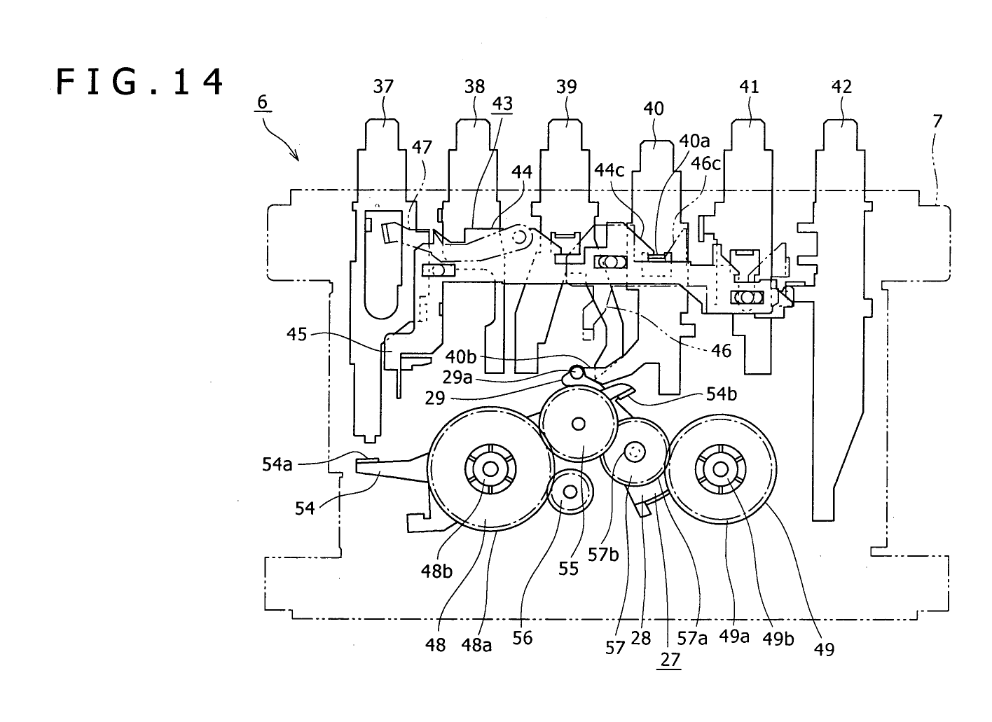

A transition from the stop mode to a rewinding mode for transporting the tape-like recording medium 100 at a high speed in a reverse direction will be described below with reference to FIG. 14.

The tape drive mechanism 6 enters the rewinding mode when the rewinding button 5d is pressed to move the rewinding lever 40 downwardly in the stop mode.

When the rewinding lever 40 is moved downwardly, the acting tooth 40a slides against the slanted edge 44c of the slider 43, moving the slider 43 to the left. When the rewinding lever 40 reaches the lower end of its movable stroke, the acting tooth 40a is positioned immediately laterally of the lock recess 44g. The slider 43 is moved to the right by the spring, causing the acting tooth 40a to engage in the lock recess 44g, whereupon the rewinding lever 40 is locked by the slider 43.

At the same time, the downward movement of the rewinding lever 40 causes the acting tooth 40a to slide against the slanted edge 46c of the switching lever 46, moving the switching lever 46 to the right. When the switching lever 46 is moved to the right, the operation tooth 46e presses the switch contact 34. The switching contacts 34, 35 are brought into contact with each other, switching on the drive motor 8, i.e., supplying a drive current to the drive motor 8.

Upon the downward movement of the rewinding lever 40, the sliding finger 40b and the actuated shaft 29a of the oscillating lever 27 slide against each other, turning the oscillating lever 27 in the R2 direction to bring the large-diameter member 57a of the two-step gear 57 into mesh with the gear 49a of the reel base 49. Therefore, the drive power of the drive motor 8 is transmitted from the large-diameter member 57a of the two-step gear 57 to the reel base 49, which is rotated at a high speed to wind the tape-like recording medium 100.

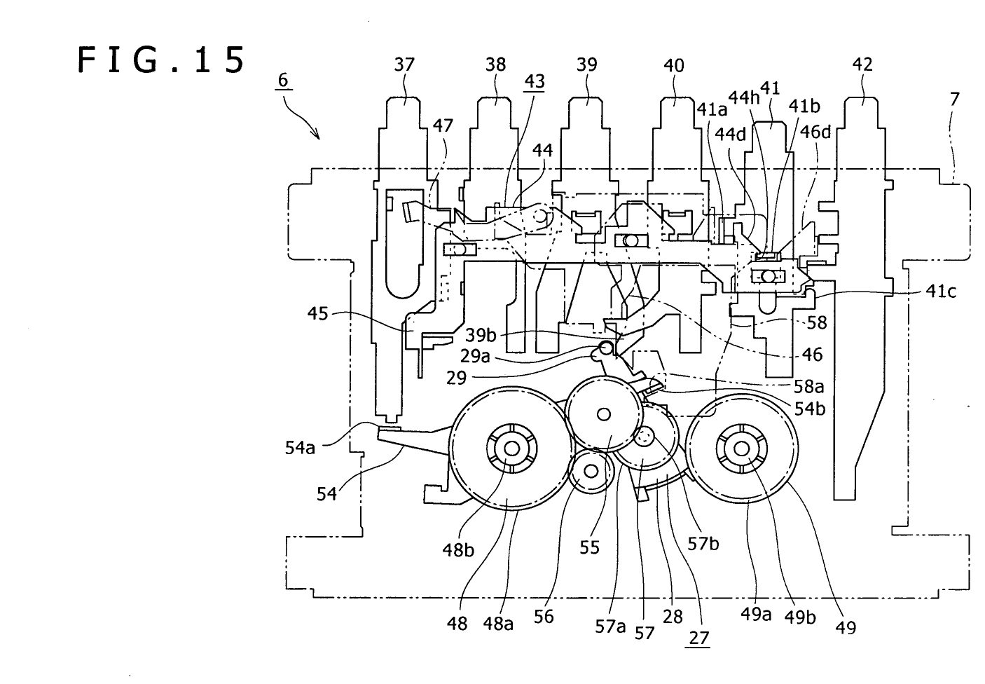

A transition from the stop mode to a reproducing mode for reproducing an information signal recorded on the tape-like recording medium 100 will be described below with reference to FIG. 15.

The tape drive mechanism 6 enters the reproducing mode when the reproducing button 5e is pressed to move the reproducing lever 41 downwardly in the stop mode.

When the reproducing lever 41 is moved downwardly, the acting tooth 41b slides against the slanted edge 44d of the slider 43, moving the slider 43 to the left. When the reproducing lever 41 reaches the lower end of its movable stroke, the acting tooth 41b is positioned immediately laterally of the lock recess 44h. The slider 43 is moved to the right by the spring, causing the acting tooth 41b to engage in the lock recess 44h, whereupon the reproducing lever 41 is locked by the slider 43.

At the same time, the downward movement of the reproducing lever 41 causes the acting tooth 41b to slide against the slanted edge 46d of the switching lever 46, moving the switching lever 46 to the right. When the switching lever 46 is moved to the right, the operation tooth 46e presses the switch contact 34. The switching contacts 34, 35 are brought into contact with each other, switching on the drive motor 8, i.e., supplying a drive current to the drive motor 8.

Upon the downward movement of the reproducing lever 41, the vertical slider 58 supported on the subchassis 36 is moved downwardly. As the vertical slider 58 is moved downwardly, the head 59 is moved downwardly, and the pinch roller 60a is moved substantially downwardly. Consequently, the head 59 and the pinch roller 60a are pressed against the tape-like recording medium 100, and the pinch roller 60a applies a constant tension to the tape-like recording medium 100.

When the vertical slider 58 is moved downwardly, the turn lever 54 is angularly moved in the R1 direction under the bias of the spring with the engaging finger 58a and the engaged tooth 54b being held in contact with each other. The interlink gear 55 supported on the turn lever 54 is brought into mesh with the small-diameter member 57b of the two-step gear 57 and the gear 48a of the reel base 48. Therefore, the drive power of the drive motor 8 is transmitted from the small-diameter member 57b of the two-step gear 57 through the interlink gear 55 to the reel base 48, which is rotated at a low speed to wind the tape-like recording medium 100. At this time, the information signal recorded on the tape-like recording medium 100 is read by the heat 59 and played back.

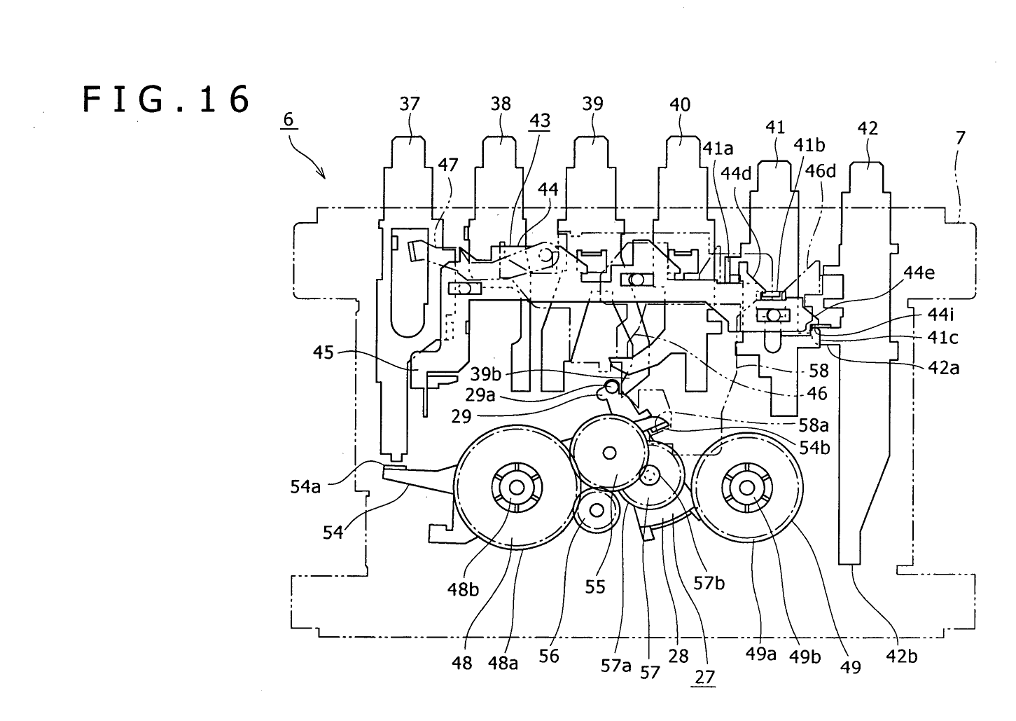

A transition from the stop mode to a recording mode for recording an information signal on the tape-like recording medium 100 will be described below with reference to FIG. 16.

The tape drive mechanism 6 enters the recording mode when the recording button 5f is pressed to move the recording lever 42 downwardly in the stop mode.

When the recording lever 42 is moved downwardly, the coupling tooth 42a slides against the slanted edge 44e of the slider 43, moving the slider 43 to the left. As the recording lever 42 is moved downwardly, the reproducing lever 41 coupled to the coupling tooth 42a of the recording lever 42 is also moved downwardly. When the recording lever 42 reaches the lower end of its movable stroke, the coupling tooth 42a is positioned immediately laterally of the lock recess 44i. The slider 43 is moved to the right by the spring, causing the coupling tooth 42a to engage in the lock recess 44i, whereupon the recording lever 42 is locked by the slider 43. The reproducing lever 41 is kept at the lower end of its movable stroke as the recording lever 42 is locked.

At the same time, the downward movement of the reproducing lever 41 upon the downward movement of the recording lever 42 causes the acting tooth 41b to slide against the slanted edge 46d of the switching lever 46, moving the switching lever 46 to the right. When the switching lever 46 is moved to the right, the operation tooth 46e presses the switch contact 34. The switching contacts 34, 35 are brought into contact with each other, switching on the drive motor 8, i.e., supplying a drive current to the drive motor 8.

Upon the downward movement of the reproducing lever 41, the vertical slider 58 supported on the subchassis 36 is moved downwardly. As the vertical slider 58 is moved downwardly, the head 59 is moved downwardly, and the pinch roller 60a is moved substantially downwardly. Consequently, the head 59 and the pinch roller 60a are pressed against the tape-like recording medium 100, and the pinch roller 60a applies a constant tension to the tape-like recording medium 100.

At the same time, the downward movement of the recording lever 42 moves the magnetic head 61a substantially downwardly until the magnetic head 61a is pressed against the tape-like magnetic medium 100.

When the vertical slider 58 is moved downwardly, the turn lever 54 is angularly moved in the R1 direction under the bias of the spring with the engaging finger 58a and the engaged tooth 54b being held in contact with each other. The interlink gear 55 supported on the turn lever 54 is brought into mesh with the small-diameter member 57b of the two-step gear 57 and the gear 48a of the reel base 48. Therefore, the drive power of the drive motor 8 is transmitted from the small-diameter member 57b of the two-step gear 57 through the interlink gear 55 to the reel base 48, which is rotated at a low speed to wind the tape-like recording medium 100. At this time, the information signal is recorded on the tape-like recording medium 100 by the head 59.

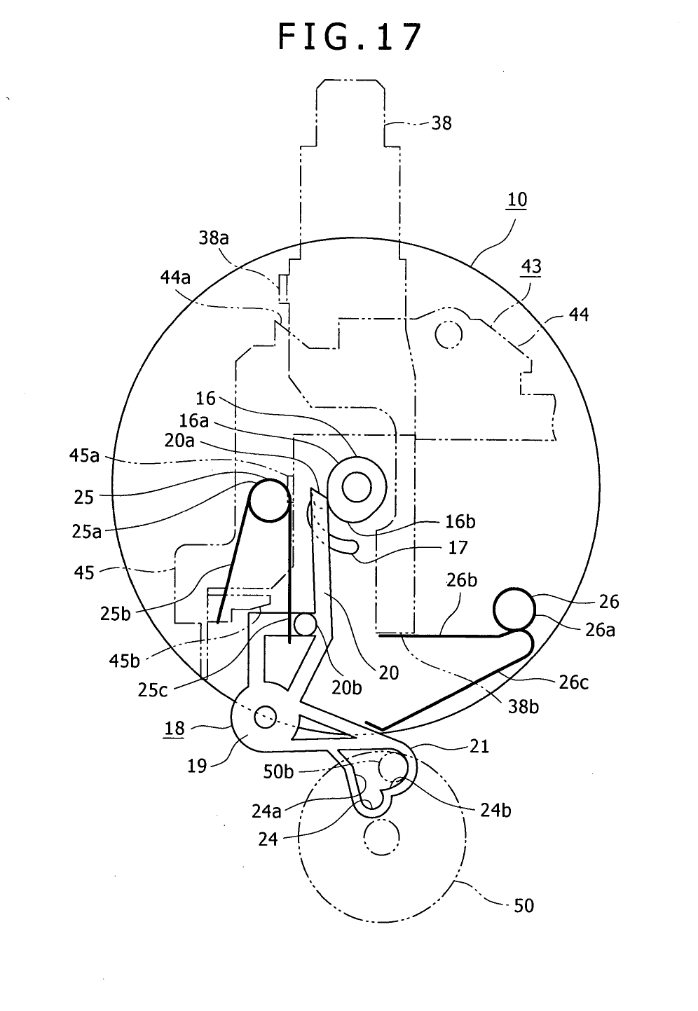

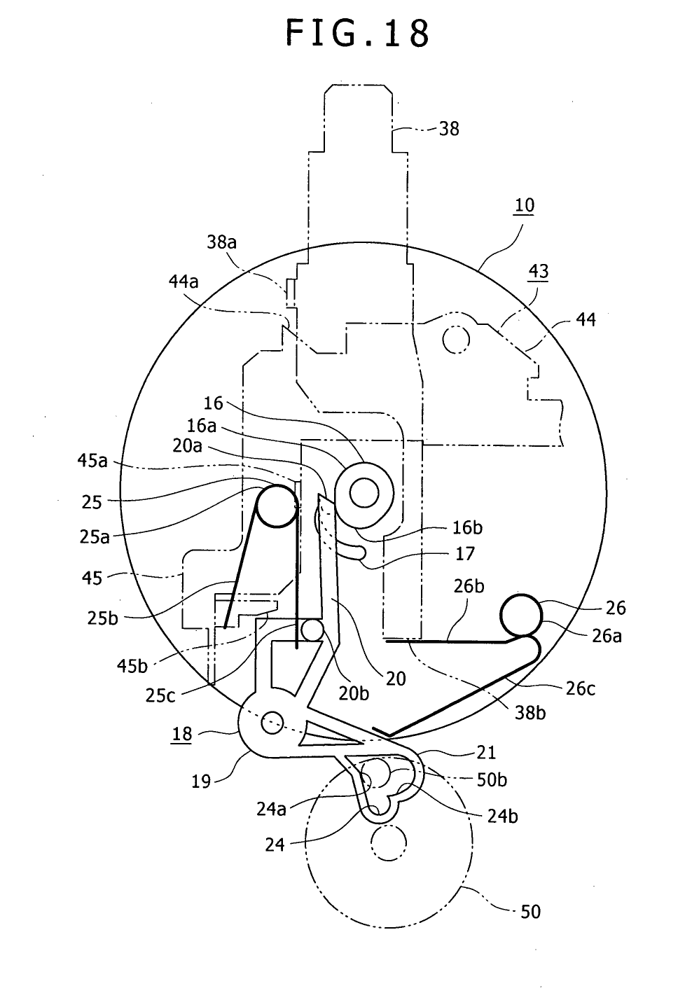

In the fast-forward mode, the rewinding mode, the reproducing mode, and the recording mode described above, the tape-like recording medium 100 is transported in a tape transport mode at the high speed or the low speed in the normal direction or the reverse direction. In the tape transport mode, the selector lever 18 is normally urged to turn in the R1 direction by the end detecting lever 50, as shown in FIGS. 17 and 18.

In the tape transport mode, the reel base 48 is rotated in the R1 direction or the R2 direction. When the reel base 48 is thus rotated, the end detecting lever 50 is made rotatable in the R1 direction or the R2 direction.

For example, when the reel base 48 is rotated in the R1 direction, the shaft 50b of the end detecting lever 50 which is inserted in the shaft insertion hole 24 of the selector lever 18 presses the right opening presser edge 24b obliquely downwardly to the right, as shown in FIG. 17. At this time, the end detecting lever 50 is rotatable in unison with the reel base 48 or is rotatable relatively to the reel base 48.

When the shaft 50b presses the right opening presser edge 24b obliquely downwardly to the right, the selector lever 18 is normally urged to turn in the R1 direction, with the cam engaging finger 20a sliding against the first cam 16 of the flywheel 10 which is in rotation.

Conversely, when the reel base 48 is rotated in the R2 direction, the shaft 50b of the end detecting lever 50 which is inserted in the shaft insertion hole 24 of the selector lever 18 presses the left opening presser edge 24a obliquely downwardly to the left, as shown in FIG. 18. At this time, the end detecting lever 50 is rotatable in unison with the reel base 48 or is rotatable relatively to the reel base 48.

When the shaft 50b presses the left opening presser edge 24a obliquely downwardly to the left, the selector lever 18 is normally urged to turn in the R1 direction, with the cam engaging finger 20a sliding against the first cam 16 of the flywheel 10 which is in rotation.

In the tape transport mode, i.e., in the fast-forward mode, the rewinding mode, the reproducing mode, and the recording mode, as shown in FIGS. 17 and 18, since the slider 43 is moved from the right end to the left end of its movable stroke, the first torsional coil spring 25 has its second arm 25c spaced leftwardly from the spring support knob 20b of the selector lever 18, which is thus not urged to turn in the R1 direction by the first torsional coil spring 25.

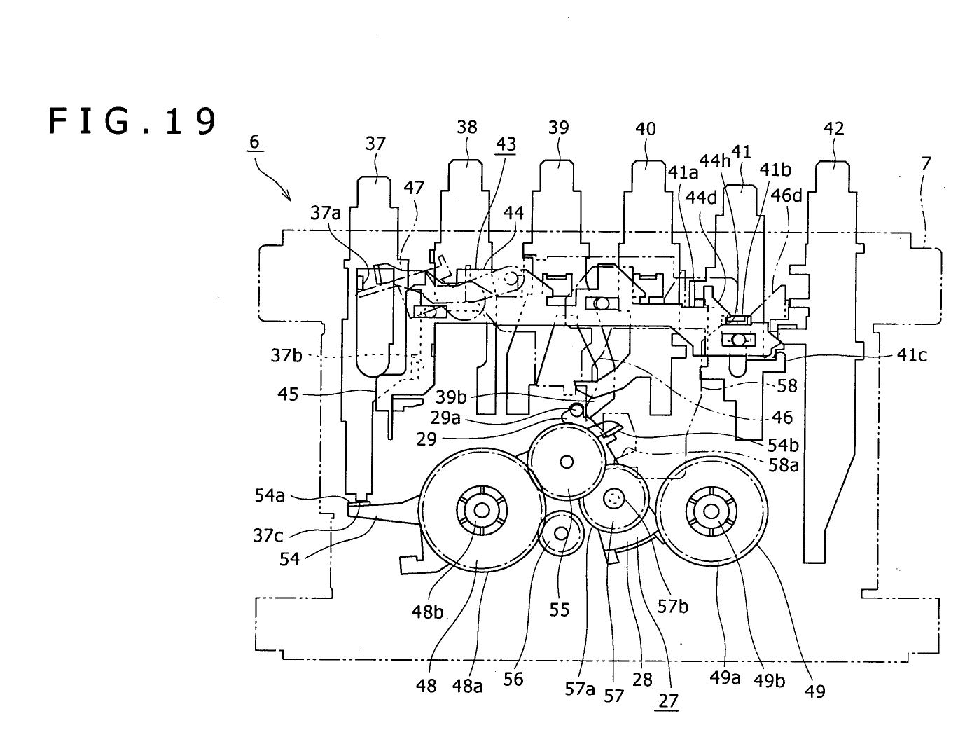

A transition to a pause mode for temporarily stopping the transportation of the tape-like recording medium 100 will be described below with reference to FIG. 19. The tape drive mechanism 6 changes from the reproducing mode or the recording mode to the pause mode. A transition from the reproducing mode to the pause mode will be described below.

The tape drive mechanism 6 enters the pause mode when the pause button 5a is pressed to move the pause lever 37 downwardly in the reproducing mode (or the recording mode).

When the pause lever 37 is moved downwardly, the pause lever 37 is locked by a lock member, not shown, mounted on the rear surface 7i of the chassis 7.

When the pause lever 37 is moved downwardly, the roller unit 60 is pressed by the presser tooth 37a and turned in the R2 direction. Therefore, the pinch roller 60a is moved substantially upwardly away from the tape-like recording medium 100, which is released from the tension.

At the same time, the pressed tooth 54a of the turn lever 54 which is turned in the R1 direction is pressed by the presser 37c of the pause lever 37, turning the turn lever 54 in the R2 direction to cause the interlink gear 55 to move out of mesh with the small-diameter member 57a of the two-step gear 57. Therefore, though the drive motor 8 is energized, the drive power thereof is not transmitted from the two-step gear 57 to the transmission gear 55, and the reel base 48 is stopped against rotation.

When the pause lever 37 is moved downwardly, the spring acting tooth 37b presses the first arm 25b of the first torsional coil spring 25 in a direction toward the second arm 25c, which is contacted by the arm 20 of the selector lever 18 from the left. Therefore, the selector lever 18 is urged to turn in the R1 direction by the first torsional coil spring 25, and the cam engaging finger 20a remains engaged by the first cam 16 of the flywheel 10 which is in rotation.

In the pause mode, as described above, the selector lever 18 is urged to turn in the R1 direction by the first torsional coil spring 25, and the cam engaging finger 20a remains engaged by the first cam 16 of the flywheel 10 which is in rotation. Consequently, the cam engaging finger 20a is not engaged by the second cam 17 of the flywheel 10 which is in rotation, so that the tape drive mechanism 6 is prevented from operating in error.

The pause mode can be canceled, i.e., the tape drive mechanism 6 can be changed from the pause mode to the reproducing mode (or the recording mode), when the pause button 5a is pressed again.

When the pause button 5a is pressed again, the pause lever 37 is moved slightly downwardly, and unlocked from the lock member. When the pause lever 37 is unlocked, the pause lever 37 is moved upwardly back to its initial position under the bias of the spring.

When the pause lever 37 is moved downwardly, the roller unit 60 is released from the presser tooth 37a, and the pinch roller 60a returns to its original position. The pressed tooth 54a is released from the presser 37c, and the turn lever 54 returns to its original position. The first arm 25b is released from the spring acting tooth 37b, and the first torsional coil spring 25 returns to its original position. The tape drive mechanism 6 now enters the reproducing mode (or the recording mode) again.

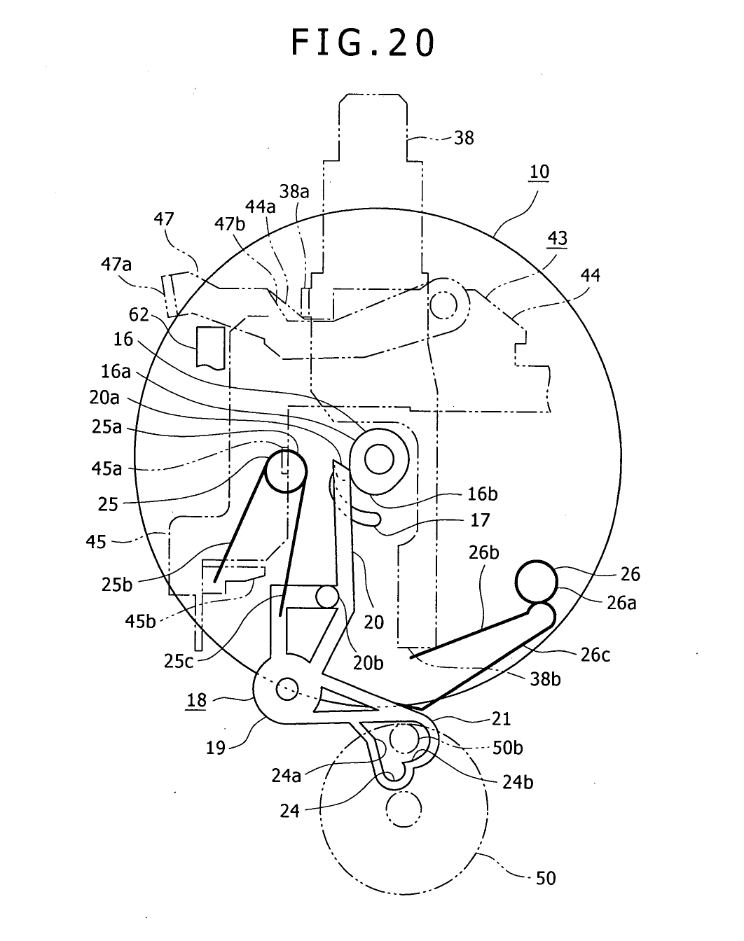

A transition to the stop mode for stopping the transportation of the tape-like recording medium 100 will be described below with reference to FIG. 20. The tape drive mechanism 6 changes to the stop mode from the tape transport mode (the fast-forward mode, the rewinding mode, the reproducing mode, or the recording mode).

The tape drive mechanism 6 enters the stop mode when the stop/ejection button 5b is pressed to move the stop lever 38 downwardly in the tape transport mode.

In the tape transport mode, as described above, the slider 43 is moved from the right end to the left end of its movable stroke, and the acting tooth 39a of the fast-forward lever 39, the acting tooth 40a of the rewinding lever 40, the acting tooth 41b of the reproducing lever 41, or the coupling tooth 42a of the recording lever 42 engages in either one of the lock recesses 44f, 44g, 44h, 44i of the slider 43, and is locked.

When the stop lever 38 is moved downwardly, the presser tooth 38a slides against the slanted edge 44a of the slider 43, moving the slider 43 to the left end of its movable stroke. When the slider 43 is moved to the left, the acting tooth 39a of the fast-forward lever 39, the acting tooth 40a of the rewinding lever 40, the acting tooth 41b of the reproducing lever 41, or the coupling tooth 42a of the recording lever 42 disengages from either one of the lock recesses 44f, 44g, 44h, 44i of the slider 43. The fast-forward lever 39, the rewinding lever 40, the reproducing lever 41, or the recording lever 42 is moved upwardly to its initial position under the bias of the spring.

When the fast-forward lever 39, the rewinding lever 40, the reproducing lever 41, or the recording lever 42 is moved upwardly, the switching lever 46 is moved to the left end of its movable stroke under the bias of the spring, and the operation tooth 46e releases the switch contact 34. The switch contacts 34, 35 are displaced away from each other, switching off the drive motor 8, i.e., stopping supplying the drive current to the drive motor 8, which is de-energized.

Upon the upward movement of the fast-forward lever 39, the rewinding lever 40, the reproducing lever 41, or the recording lever 42, the various parts, e.g., the oscillating lever 27 and the turn lever 54, return to their initial positions, bringing the tape drive mechanism 6 into the stop mode.

When the stop lever 38 is moved downwardly, the presser tooth 38a is simultaneously inserted into the clearance recess 47b of the ejection arm 47, which is not turned, but moved to the left with the slider 43. The ejection arm 47 and the slider 43 are moved to the left end of their movable stroke.

After the tape drive mechanism 6 has entered the stop mode, when the stop/ejection button 5b is released, the stop lever 38 is moved upwardly back to its initial position under the bias of the spring.

When the stop lever 38 is moved upwardly, since the presser tooth 38a and the slanted edge 44a disengage from each other, the slider 43 returns to the right end of its movable stroke under the bias of the spring, as shown in FIG. 11.

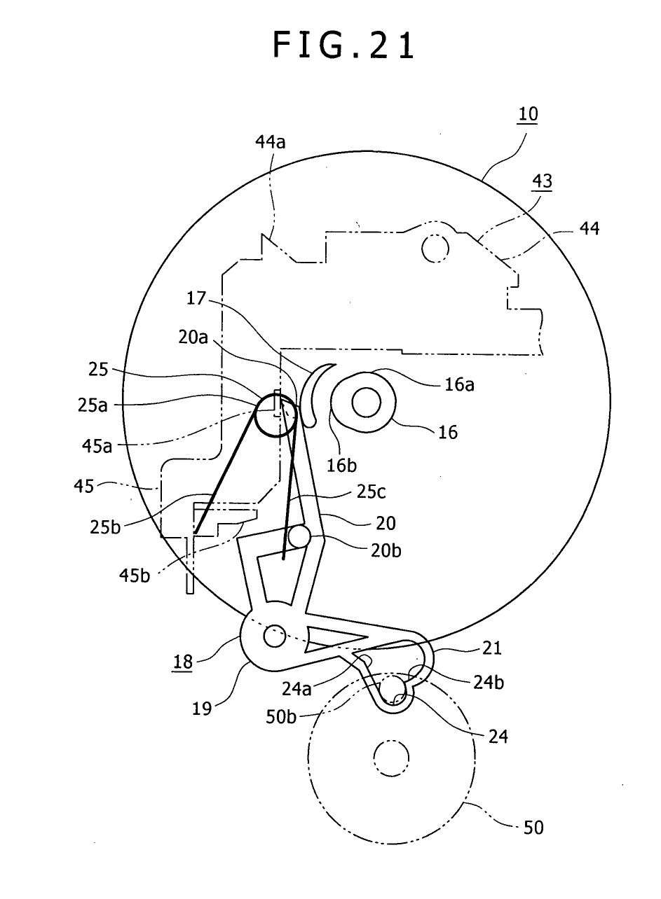

An automatic stop function of the tape drive device 1 will be described below with reference to FIG. 21. The automatic stop function is performed to automatically bring the tape drive mechanism 6 into the stop mode when the end detecting lever 50 detects the starting end or terminal end of the tape-like recording medium 100.

When the tape-like recording medium 100 is wound to its starting end or terminal end on the reel base 48 in the tape transport mode, the reel base 48 is stopped against rotation, and the end detecting lever 50 stopped against rotation. When the end detecting lever 50 stopped against rotation, the biasing force applied from the end detecting lever 50 to the selector lever 18 is eliminated. Since no biasing force is applied from the first torsional coil spring 25 to the selector lever 18 in the tape transport mode as described above with reference to FIGS. 17 and 18, the selector lever 18 is angularly movable in any directions.

When the flywheel 10 is rotated by the inertial force of the drive motor 8, the cam engaging finger 20a of the selector lever 18 moves relatively around the arcuate portion 16a and the displacement portion 16b of the first cam 16, and the selector lever 18, which is free of the biasing force in the R1 direction, has its cam engaging finger 20a engaged by and sliding against the outer surface of the second cam 17, as shown in FIG. 21.

When the cam engaging finger 20a is engaged by the second cam 17, the selector lever 18 is turned in the R2 direction, and the pressed tooth 45a of the slider 43 is pressed by the cam engaging finger 20a from the right, moving the slider 43 to the left. Therefore, as when the stop lever 38 is moved downwardly, the acting tooth 39a of the fast-forward lever 39, the acting tooth 40a of the rewinding lever 40, the acting tooth 41b of the reproducing lever 41, or the coupling tooth 42a of the recording lever 42 disengages from either one of the lock recesses 44f, 44g, 44h, 44i of the slider 43. The fast-forward lever 39, the rewinding lever 40, the reproducing lever 41, or the recording lever 42 is moved upwardly to its initial position under the bias of the spring.

When the fast-forward lever 39, the rewinding lever 40, the reproducing lever 41, or the recording lever 42 is moved upwardly, the switching lever 46 is moved to the left end of its movable stroke under the bias of the spring, and the operation tooth 46e releases the switch contact 34. The switch contacts 34, 35 are displaced away from each other, switching off the drive motor 8, i.e., stopping supplying the drive current to the drive motor 8, which is de-energized. At the same time, the various parts, e.g., the oscillating lever 27 and the turn lever 54, return to their initial positions, bringing the tape drive mechanism 6 into the stop mode.

Since the pressed tooth 45a of the slider 43 that is urged to the right by the spring is engaged by the cam engaging finger 20a from the left, when the flywheel 10 is turned rotated by the inertial force of the drive motor 8 to release the cam engaging finger 20a of the selector lever 18 from the second cam 17, the slider 43 returns to the right end of its movable stroke under the bias of the spring. The selector lever 18 is turned in the R1 direction with its cam engaging finger 20a being pressed by the pressed tooth 45a.

The selector lever 18 has its spring support knob 20b pressed to the right by the second arm 25c of the first torsional coil spring 25, and is urged to turn in the R1 direction by the first torsional coil spring 25. The cam engaging finger 20a is again engaged by the first cam 16 of the flywheel 10.

In the tape transport mode described above, the end detecting lever 50 urges the selector lever 18 to turn in the R1 direction, and is rotated while a certain load is being applied to the reel base 48 by the second load adjustment spring 53.

At this time, the load on the rotation of the reel base 48 with respect to the chassis 7 and the load on the rotation of the end detecting lever 50 with respect to the reel base 48 may vary depending on the environment in which the tape drive device 1 is used, e.g., when the tape drive device 1 is used at a high temperature. For example, if the load on the rotation of the end detecting lever 50 with respect to the reel base 48 varies, then the selector lever 18 may accidentally be turned in the R2 direction. In worst cases, while the tape-like recording medium 100 is being transported, the pressed tooth 45a of the slider 43 may be pressed by the cam engaging finger 20a of the selector lever 18, bringing the tape drive device 1 into the tape transport stop mode.

However, the tape drive device 1 has the first load adjustment spring 52 for imposing a load on the rotation of the reel base 48 with respect to the chassis 7 and the second load adjustment spring 53 for imposing a load on the rotation of the end detecting lever 50 with respect to the reel base 48, with the second load adjustment spring 53 being used as a dedicated member for imposing a load on the rotation of the end detecting lever 50 with respect to the reel base 48. Therefore, the adjustment of the load on the rotation of the end detecting lever 50 with respect to the reel base 48 can be managed separately from the adjustment of the load on the rotation of the reel base 48 with respect to the chassis 7, so that the tape drive device 1 is prevented from accidentally entering the tape transport stop mode while the tape-like recording medium 100 is being transported.

Furthermore, when the cam engaging finger 20a of the selector lever 18 is engaged by the second cam 17, the cam engaging finger 20a presses the pressed tooth 45a of the slider 43, bringing the tape drive device 1 into the tape transport mode. Consequently, the tape drive device 1 can easily and reliably enter the tape transport mode.

Each of the first load adjustment spring 52 and the second load adjustment spring 53 includes a compression coil spring. Since the first load adjustment spring 52 and the second load adjustment spring 53 are substantially coaxial with the centers of rotation of the reel base 48 and the end detecting lever 50, the load on the rotation of the reel base 48 with respect to the chassis 7 and the load on the rotation of the end detecting lever 50 with respect to the reel base 48 can be adjusted highly accurately, and the reel base 48 and the end detecting lever 50 are prevented from being shifted out of axial alignment while in rotation.

In addition, the spring retainer 51 is of a circular profile, and is held in substantially axial alignment with the centers of rotation of the reel base 48 and the end detecting lever 50. Therefore, the spring retainer 51 is of a simple structure, and the reel base 48 and the end detecting lever 50 are prevented from being shifted out of axial alignment while in rotation.

Operation of the tape drive mechanism 6 when it changes from the tape transport mode to the stop mode will be described below with reference to FIG. 20.

When the tape drive mechanism 6 changes from the tape transport mode to the stop mode, the slider 43 and the ejection arm 47 move to the left end of their movable stroke. At this time, the presser tooth 47a of the ejection arm 47 is positioned leftwardly of the ejection lever 62. Even if the ejection arm 47 is turned to move the presser tooth 47a substantially downwardly, the presser tooth 47a does not press the ejection lever 62, and hence the tape cassette 200 is not ejected.

When the tape drive mechanism 6 enters the stop mode, the drive motor 8 rotates due to inertia, rotating the flywheel 10 with respect to the cam engaging finger 20a of the selector lever 18.

When the stop lever 38 remains moved downwardly, the first arm 26b of the second torsional coil spring 26 is pressed downwardly by the presser tooth 38a, and the acting protrusion 21 of the selector lever 18 is pressed downwardly by the second arm 26c. The selector lever 18 is urged to turn in the R1 direction by the second torsional coil spring 26, and the cam engaging finger 20a slides against only the first cam 16 of the flywheel 10, but not against the second cam 17. Therefore, while the stop lever 38 is moved downwardly, the second torsional coil spring 26 applies a force tending to turn the selector lever 18 in the R1 direction, and functions as an acting member for causing the cam engaging finger 20a to engage the first cam 16 of the flywheel 10.

Since the cam engaging finger 20a slides against only the first cam 16 of the flywheel 10, after the stop/ejection button 5b is released and the stop lever 38 is moved upwardly, the selector lever 18 urged by the first torsional coil spring 25 has its cam engaging finger 20a engaged by the first cam 16 at all times. Therefore, when the stop lever 38 is moved upwardly, the cam engaging finger 20a is not engaged by the second cam 17 and does not contact the pressed tooth 45a, preventing the slider 43 from being held leftwardly of the right end of the movable stroke thereof. Rather, when the stop lever 38 is moved upwardly, the presser tooth 47a of the ejection arm 47 is positioned directly above the ejection lever 62 at all times, as shown in FIG. 12.

When the stop/ejection button 5b is pressed to move the stop lever 38 downwardly, therefore, the ejection lever 38 is always pressed and moved downwardly by the presser tooth 47a, ejecting the tape cassette 200.

As described above, the tape drive device 1 has the second torsional coil spring 26 functioning as an acting member for turning the selector lever 18 in the R1 direction to bring the cam engaging finger 20a into engagement with the first cam 16 of the flywheel 10 while the stop lever 38 is moved downwardly. Consequently, when the drive motor 8 rotates due to inertia, the cam engaging finger 20a does not engage the second cam 17, so that the tape drive device 1 is prevented from malfunctioning and operates with increased reliability.

Furthermore, after the second torsional coil spring 26 urges the selector lever 18 to turn in the R1 direction and the stop lever 38 is moved upwardly, when the stop lever 38 is moved downwardly again, the presser tooth 47a of the ejection arm 47 is positioned immediately above the ejection lever 62 at all times. Therefore, the tape cassette 200 is reliably ejected.

In addition, inasmuch as the acting member includes a spring in the form of the second torsional coil spring 26, the tape drive device 1 allows the tape cassette 200 to be ejected reliably by a simple structure.

Although a certain preferred embodiment of the present invention has been shown and described in detail, it should be understood that various changes and modifications may be made therein without departing from the scope of the appended claims.

What is claimed is:

1. A tape drive device comprising:
a flywheel rotatable by drive power from a drive motor, said flywheel including a first cam positioned at a center of rotation thereof and a second cam positioned radially outwardly from said first cam;
a pair of reel bases configured to wind a tape-like recording medium thereon, said reel bases being rotatably supported on a chassis and rotatable by the drive power transmitted from the drive motor through said flywheel;
an end detecting lever configured to detect a starting end or terminal end of said tape-like recording medium, said end detecting lever being rotatably supported on one of said reel bases and rotatable between said chassis and said one of the reel bases depending on rotation of said one of the reel bases; and
a selector lever angularly movably supported on said chassis configured to switch selectively between a tape transport mode and a tape transport stop mode depending on the angular position thereof, said selector lever being normally urged to turn in a predetermined direction by said end detecting lever while said reel bases are in rotation;
wherein said selector lever including a cam engaging member configured to engage said first cam of said flywheel to provide said tape transport mode and engage said second cam of said flywheel to provide said tape transport stop mode, depending on whether said selector lever is urged by said end detecting lever or not,
a spring retainer fixed to said one of the reel bases between said chassis and said end detecting lever,
a first load adjustment spring disposed between said spring retainer and said chassis configured to adjust a load applied in the direction of a rotational shaft of said one of the reel bases with respect to said chassis, and
a second load adjustment spring disposed between said spring retainer and said end detecting lever configured to adjust a load applied in the direction of a rotational shaft of said end detecting lever with respect to said one of the reel bases.

2. The tape drive device according to claim 1, further comprising
a slider slidably supported on said chassis configured to convert between said tape transport mode and said tape transport stop mode depending on the position thereof with respect to said chassis,
wherein when said cam engaging member of said selector lever is engaged by said second cam of said flywheel, said cam engaging member presses said slider to provide said tape transport mode.

3. The tape drive device according to claim 1, wherein each of said first load adjustment spring and said second load adjustment spring includes a compression spring, said first load adjustment spring and said second load adjustment spring are held in substantially axial alignment with the centers of rotation of said reel bases.

4. The tape drive device according to claim 1, wherein said spring retainer is of a circular profile, said spring retainer being held in substantially axial alignment with the centers of rotation of said one of the reel bases and said end detecting lever.

5. The tape drive device according to claim 1, further comprising:
a stop lever movably supported on said chassis configured to stop transporting said tape-like recording medium when said stop lever is moved in a first direction; and
an acting member configured to apply a turning force in said predetermined direction to said selector lever to cause said cam engaging member to engage said first cam of said flywheel when said stop lever is moved in said first direction.

6. The tape drive device according to claim 5, further comprising
an ejection lever movably supported on said chassis configured to eject said tape-like recording medium,
wherein said ejection lever ejects a tape cassette housing said tape-like recording medium when said stop lever is moved in said first direction while said cam engaging member of said selector lever is engaging said first cam of said flywheel.

7. The tape drive device according to claim 5, wherein a spring is used as said acting member.
